(19) United States
(12) Patent Application Publication
(10) Pub. No.: US 2026/0106505 A1
(43) Pub. Date: Apr. 16, 2026

(54) STATOR AND AXIAL FLUX MOTOR INCLUDING THE SAME

(71) Applicants: HYUNDAI MOTOR COMPANY, Seoul (KR); KIA CORPORATION, Seoul (KR); GACHON UNIVERSITY OF INDUSTRY-ACADEMIC COOPERATION FOUNDATION, Seongnam-si (KR)

(72) Inventors: Seong-Bin Jeong, Hwaseong-si (KR); Yong Woong Cha, Hwaseong-si (KR); Jae-Eun Jeong, Hwaseong-si (KR); Soo Yong Park, Hwaseong-si (KR); Won-Ho Kim, Hwaseong-si (KR); Dong-Woo Nam, Anyang-si (KR); In-Jun Yang, Seongnam-si (KR); Min-Ki Hong, Seoul (KR); Min-Su Youn, Yongin-si (KR)

(73) Assignees: HYUNDAI MOTOR COMPANY, Seoul (KR); KIA CORPORATION, Seoul (KR); GACHON UNIVERSITY OF INDUSTRY-ACADEMIC COOPERATION FOUNDATION, Seongnam-si (KR)

(21) Appl. No.: 19/230,528

(22) Filed: Jun. 6, 2025

(30) Foreign Application Priority Data
Oct. 10, 2024 (KR) 10-2024-0137413

(51) Int. Cl. H02K 3/26; H02K 21/24

(52) U.S. Cl. CPC H02K 3/26; H02K 21/24; H02K 2203/03

(57) ABSTRACT

A stator coil includes: a U-phase coil, a V-phase coil, and a W-phase coil. Each of the U-phase coil, V-phase coil, and W-phase coil includes a plurality of main mid-turn assemblies disposed at set intervals along a circumferential direction. Each of the U-phase coil, V-phase coil, and W-phase coil further includes a plurality of end turns that electrically connect adjacent main mid-turn assemblies on a radially inner side and a radially outer side, respectively.

### CROSS-REFERENCE TO RELATED APPLICATION

This application claims priority to and the benefit of Korean Patent Application No. 10-2024-0137413 filed in the Korean Intellectual Property Office on Oct. 10, 2024, the entire contents of which are incorporated herein by reference.

### TECHNICAL FIELD

The present disclosure relates to a stator and an axial flux motor including the stator, and more particularly, the present disclosure relates to a stator and an axial flux motor including the stator that may maximize a high winding coefficient and flux linkage.

### BACKGROUND

An axial flux motor (AFM) is an electric motor in which the magnetic flux is directed in the axial direction. The axial flux motor is known to have high torque density and high efficiency in a thin structure compared to a radial flux motor (RFM) in which the magnetic flux is directed in the radial direction. Axial magnetic flux motors are used in various fields because the magnetic flux motors are easier to modularize and reduce volume compared to radial flux motors.

Conventionally, a spiral coil pattern in the form of concentrated winding is applied to a stator applied to an axial flux motor. Because the areas of radial inner coil turns and radial outer coil turns are different in this concentrated coil pattern, a magnetic linkage from a permanent magnet may not be constant.

The area of the radial inner coil turns is narrow, so the actual flux linkage is small, which is inefficient, and because the available winding methods are limited, there is also a limit in terms of the turns coefficient.

The above information disclosed in this Background section is only for enhancement of understanding of the background of the present disclosure, and therefore this Background section may contain information that does not form the prior art that is already known to a person of ordinary skill in the art.

### SUMMARY

An object of the present disclosure is to provide a stator and an axial flux motor including the stator that may maximize a flux linkage area according to the number of turns of the coil by manufacturing a stator coil in the form of distributed winding.

An embodiment provides a stator coil including: a U-phase coil, a V-phase coil, and a W-phase coil. Each of the U-phase coil, V-phase coil, and W-phase coil includes a plurality of main mid-turn assemblies disposed at set intervals along a circumferential direction. Each of the U-phase coil, V-phase coil, and W-phase coil includes a plurality of end turns that electrically connect adjacent main mid-turn assemblies on a radially inner side and a radially outer side, respectively.

In some embodiments, each of the plurality of main mid-turn assemblies may include a plurality of auxiliary mid-turn assemblies disposed along the circumferential direction.

In some embodiments, each of the auxiliary mid-turn assemblies may include a plurality of mid-turns disposed in parallel in an axial direction.

In some embodiments, the end turn may include a plurality of inner end turns having an arc shape and positioned radially inside a main mid-turn assembly among the plurality of main mid-turn assemblies. The end turn may include a plurality of outer end turns having an arc shape and positioned radially outside the main mid-turn assembly.

In some embodiments, the inner end turn may electrically connect another main mid-turn assembly and an additional main mid-turn assembly respectively adjacent to a first side and a second side of the circumferential direction of one main mid-turn assembly.

In some embodiments, the outer end turn may electrically connect the another main mid-turn assembly and the additional main mid-turn assembly respectively adjacent to the first side and the second side of the circumferential direction of the one main mid-turn assembly.

In some embodiments, the plurality of auxiliary mid-turn assemblies may include a first auxiliary mid-turn assembly, a second auxiliary mid-turn assembly, and a third auxiliary mid-turn assembly. The inner end turn may include a first inner end turn electrically connecting the first auxiliary mid-turn assembly of the one main mid-turn assembly and the third auxiliary mid-turn assembly of the another main mid-turn assembly adjacent to the first side of the circumferential direction of the one main mid-turn assembly. The inner end turn may further include a (2-1)-th inner end turn electrically connecting the third auxiliary mid-turn assembly of the one main mid-turn assembly and the first auxiliary mid-turn assembly of the additional main mid-turn assembly adjacent to the second side of the circumferential direction of the one main mid-turn assembly. The inner end turn may further include a (2-2)-th inner end turn electrically connecting the second auxiliary mid-turn assembly of the one main mid-turn assembly and the second auxiliary mid-turn assembly of the additional main mid-turn assembly adjacent to the second side in the circumferential direction of the one main mid-turn assembly.

In some embodiments, the outer end turn may include a (1-1)-th outer end turn electrically connecting one the third auxiliary mid-turn assembly of the one main mid-turn assembly and the first auxiliary mid-turn assembly of the another main mid-turn assembly adjacent to the first side of the circumferential direction of the one main mid-turn assembly. The outer end turn may further include a (1-2)-th outer end turn electrically connecting the first auxiliary mid-turn assembly of the one main mid-turn assembly and the second auxiliary mid-turn assembly of the another main mid-turn assembly adjacent to the first side of the circumferential direction of the one main mid-turn assembly. The outer end turn may further include a second outer end turn electrically connecting the second auxiliary mid-turn assembly of the one main mid-turn assembly and the first auxiliary mid-turn assembly of the additional main mid-turn assembly adjacent to the second side of the circumferential direction of the one main mid-turn assembly.

In some embodiments, the plurality of auxiliary mid-turn assemblies may include a first auxiliary mid-turn assembly, a second auxiliary mid-turn assembly, a third auxiliary mid-turn assembly, a fourth auxiliary mid-turn assembly, and a fifth auxiliary mid-turn assembly. The inner end turn may include a first auxiliary mid-turn assembly, a second auxiliary mid-turn assembly, a third auxiliary mid-turn assembly, a fourth auxiliary mid-turn assembly, and a fifth auxiliary mid-turn assembly. The inner end turn may further include a (1-1)-th inner end turn electrically connecting the second auxiliary mid-turn assembly of the one main mid-turn assembly and the fifth auxiliary mid-turn assembly of the another main mid-turn assembly adjacent to the first side of the circumferential direction of the one main mid-turn assembly. The inner end turn may further include a (1-2)-th inner end turn electrically connecting the third auxiliary mid-turn assembly of the one main mid-turn assembly and the fourth auxiliary mid-turn assembly of the another main mid-turn assembly adjacent to the first side of the circumferential direction of the one main mid-turn assembly. The inner end turn may further include a (1-3)-th inner end turn electrically connecting the first auxiliary mid-turn assembly of the one main mid-turn assembly and the third auxiliary mid-turn assembly of the another main mid-turn assembly adjacent to the first side of the circumferential direction of the one main mid-turn assembly. The inner end turn may further include a (2-1)-th inner end turn electrically connecting the fifth auxiliary mid-turn assembly of the one main mid-turn assembly and the first auxiliary mid-turn assembly of the additional main mid-turn assembly adjacent to the second side of the circumferential direction of the one main mid-turn assembly. The inner end turn may further include a (2-2)-th inner end turn electrically connecting the fourth auxiliary mid-turn assembly of the one main mid-turn assembly and the second auxiliary mid-turn assembly of the additional main mid-turn assembly adjacent to the second side of the circumferential direction of the one main mid-turn assembly.

In some embodiments, the outer end turn may include a (1-1)-th outer end turn electrically connecting the first auxiliary mid-turn assembly of the one main mid-turn assembly and the fifth auxiliary mid-turn assembly of the another main mid-turn assembly adjacent to the first side of the circumferential direction of the one main mid-turn assembly. The outer end turn may further include a (1-2)-th outer end turn electrically connecting the second auxiliary mid-turn assembly of the one main mid-turn assembly and the fourth auxiliary mid-turn assembly of the another main mid-turn assembly adjacent to the first side of the circumferential direction of the one main mid-turn assembly. The outer end turn may further include a (2-1)-th outer end turn electrically connecting the third auxiliary mid-turn assembly of the one main mid-turn assembly and the first auxiliary mid-turn assembly of the additional main mid-turn assembly adjacent to the second side of the circumferential direction of the one main mid-turn assembly. The outer end turn may further include a (2-2)-th outer end turn electrically connecting the fifth auxiliary mid-turn assembly of the one main mid-turn assembly and the second auxiliary mid-turn assembly of the additional main mid-turn assembly adjacent to the second side of the circumferential direction of the one main mid-turn assembly. The outer end turn may further include a (2-3)-th outer end turn electrically connecting the fourth auxiliary mid-turn assembly of the one main mid-turn assembly and the third auxiliary mid-turn assembly of the additional main mid-turn assembly adjacent to the second side of the circumferential direction of the one main mid-turn assembly.

In some embodiments, the inner end turn may electrically connect one one main mid-turn assembly and another main mid-turn assembly adjacent to a first side of the circumferential direction of the one main mid-turn assembly. The inner end turn electrically connects the another main mid-turn assembly and additional main mid-turn assembly adjacent to a first side of of the circumferential direction of the another main mid-turn assembly.

In some embodiments, the outer end turn may electrically connect the one main mid-turn assembly and further main mid-turn assembly adjacent to the first side of the circumferential direction of the one main mid-turn assembly. The outer end turn electrically connects the additional main mid-turn assembly adjacent to a first side of the circumferential direction of the further main mid-turn assembly.

In some embodiments, the plurality of auxiliary mid-turn assemblies may include a first auxiliary mid-turn assembly, a second auxiliary mid-turn assembly, a third auxiliary mid-turn assembly, and a fourth auxiliary mid-turn assembly. The inner end turn may include a (1-1)-th inner end turn electrically connecting the second auxiliary mid-turn assembly of the one main mid-turn assembly and the second auxiliary mid-turn assembly of the further main mid-turn assembly adjacent to the first side of the circumferential direction of the one main mid-turn assembly. The inner end turn may further include a (1-2)-th inner end turn electrically connecting the third auxiliary mid-turn assembly of the one main mid-turn assembly and the first auxiliary mid-turn assembly of the further main mid-turn assembly adjacent to the first side of the circumferential direction of the one main mid-turn assembly. The inner end turn may further include a (1-3)-th inner end turn electrically connecting the fourth auxiliary mid-turn assembly of the one main mid-turn assembly and the third auxiliary mid-turn assembly of the further main mid-turn assembly adjacent to the first side of the circumferential direction of the one main mid-turn assembly. The inner end turn may further include a second inner end turn electrically connecting the first auxiliary mid-turn assembly of extra main mid-turn assembly adjacent to the first side of the circumferential direction of the further main mid-turn assembly and the fourth auxiliary mid-turn assembly of the further main mid-turn assembly adjacent to the first side of the circumferential direction of the one main mid-turn assembly.

In some embodiments, the outer end turn may include a (1-1)-th outer end turn electrically connecting the third auxiliary mid-turn assembly of the one main mid-turn assembly and the third auxiliary mid-turn assembly of the further main mid-turn assembly adjacent to the first side of the circumferential direction of the one main mid-turn assembly. The outer end turn may further include a (1-1)-th outer end turn electrically connecting the third auxiliary mid-turn assembly of the one main mid-turn assembly and the third auxiliary mid-turn assembly of the further main mid-turn assembly adjacent to the first side of the circumferential direction of the one main mid-turn assembly. The outer end turn may further include a (1-2)-th outer end turn electrically connecting the fourth auxiliary mid-turn assembly of the one main mid-turn assembly and the first auxiliary mid-turn assembly of the another main mid-turn assembly adjacent to the first side of the circumferential direction of the one main mid-turn assembly. The outer end turn may further include a (2-1)-th outer end turn electrically connecting the third auxiliary mid-turn assembly of the another main mid-turn assembly adjacent to the first side of the circumferential direction of the one main mid-turn assembly and the first auxiliary mid-turn assembly of the additional main mid-turn assembly adjacent to the first side of the circumferential direction of the another main mid-turn assembly. The outer end turn may further include a (2-2)-th outer end turn electrically connecting the fourth auxiliary mid-turn assembly of the another main mid-turn assembly adjacent to the first side of the circumferential direction of the one main mid-turn assembly and the second auxiliary mid-turn assembly of the additional main mid-turn assembly adjacent to the first side of the circumferential direction of the another main mid-turn assembly.

In some embodiments, the plurality of auxiliary mid-turn assemblies may a first auxiliary mid-turn assembly, a second auxiliary mid-turn assembly, a third auxiliary mid-turn assembly, a fourth auxiliary mid-turn assembly, a fifth auxiliary mid-turn assembly, and a sixth mid-turn auxiliary assembly. The inner end turn may include a (1-1)-th inner end turn electrically connecting the third auxiliary mid-turn assembly of the one main mid-turn assembly and the second auxiliary mid-turn assembly of the another main mid-turn assembly adjacent to the first side of the circumferential direction of the one main mid-turn assembly. The inner end turn may further include a (1-2)-th inner end turn electrically connecting the fourth auxiliary mid-turn assembly of the one main mid-turn assembly and the first auxiliary mid-turn assembly of the another main mid-turn assembly adjacent to the first side of the circumferential direction of the one main mid-turn assembly. The inner end turn may further include a (1-3)-th inner end turn electrically connecting the fifth auxiliary mid-turn assembly of the one main mid-turn assembly and the fourth auxiliary mid-turn assembly of the another main mid-turn assembly adjacent to the first side of the circumferential direction of the one main mid-turn assembly. The inner end turn may further include a (1-4)-th inner end turn electrically connecting the sixth auxiliary mid-turn assembly of the one main mid-turn assembly and the third auxiliary mid-turn assembly of the another main mid-turn assembly adjacent to the first side of the circumferential direction of the one main mid-turn assembly. The inner end turn may further include a (2-1)-th inner end turn electrically connecting the fifth auxiliary mid-turn assembly of the another main mid-turn assembly adjacent to the first side of the circumferential direction of the one main mid-turn assembly and the second auxiliary mid-turn assembly of the additional main mid-turn assembly adjacent to the first side of the circumferential direction of the another main mid-turn assembly. The inner end turn may further include a (2-2)-th inner end turn electrically connecting the sixth auxiliary mid-turn assembly of the another main mid-turn assembly adjacent to the first side of the circumferential direction of the one main mid-turn assembly and the first auxiliary mid-turn assembly of the additional main mid-turn assembly adjacent to the first side of the circumferential direction of the another main mid-turn assembly.

In some embodiments, the outer end turn may include a (1-1)-th outer end turn electrically connecting the fourth auxiliary mid-turn assembly of the one main mid-turn assembly and the second auxiliary mid-turn assembly of the another main mid-turn assembly adjacent to the first side of the circumferential direction of the one main mid-turn assembly. The outer end turn may further include a (1-2)-th outer end turn electrically connecting the fifth auxiliary mid-turn assembly of the one main mid-turn assembly and the first auxiliary mid-turn assembly of the another main mid-turn assembly adjacent to the first side of the circumferential direction of the one main mid-turn assembly. The outer end turn may further include a (1-3)-th outer end turn electrically connecting the sixth auxiliary mid-turn assembly of the one main mid-turn assembly and the fourth auxiliary mid-turn assembly of the another main mid-turn assembly adjacent to the first side of the circumferential direction of the one main mid-turn assembly. The outer end turn may further include a (2-1)-th outer end turn electrically connecting the third auxiliary mid-turn assembly of the another main mid-turn assembly adjacent to the first side of the circumferential direction of the one main mid-turn assembly and the second auxiliary mid-turn assembly of the additional main mid-turn assembly adjacent to the first side of the circumferential direction of the another main mid-turn assembly. The outer end turn may further include a (2-2)-th outer end turn electrically connecting the fifth auxiliary mid-turn assembly of the another main mid-turn assembly adjacent to the first side of the circumferential direction of the one main mid-turn assembly and the first auxiliary mid-turn assembly of the additional main mid-turn assembly adjacent to the first side of the circumferential direction of the another main mid-turn assembly. The outer end turn may further include a (2-3)-th outer end turn electrically connecting the sixth auxiliary mid-turn assembly of the another main mid-turn assembly adjacent to the first side of the circumferential direction of the one main mid-turn assembly and the third auxiliary mid-turn assembly of the additional main mid-turn assembly adjacent to the first side of the circumferential direction of the another main mid-turn assembly.

Another embodiment provides an axial flux motor including: a stator PCB pattern including a stator coil; a permanent magnet disposed on both sides of the stator PCB pattern; and a rotor core disposed on both sides of the permanent magnet. The stator coil comprising a U-phase coil, a V-phase coil, and a W-phase coil.

Each of the U-phase coil, V-phase coil, and W-phase coil includes: a plurality of main mid-turn assemblies disposed at set intervals along a circumferential direction; and a plurality of end turns that electrically connect adjacent main mid-turn assemblies on a radially inner side and a radially outer side, respectively. Each of the plurality of main mid-turn assemblies includes a plurality of auxiliary mid-turn assemblies disposed along the circumferential direction. Each of the auxiliary mid-turn assemblies includes a plurality of mid-turns disposed in parallel in an axial direction.

According to the embodiments, each of the U-phase coil, the V-phase coil, and the W-phase coil may be wound in a distributed winding form. Accordingly, the stator coil may be wound through various winding methods, and the winding coefficient may be maximized.

In addition, the effects that may be obtained or expected from the embodiments of the present disclosure should be directly or implicitly disclosed in the detailed description of the present disclosure. In other words, various effects expected from the embodiments of the present disclosure are described in the following detailed description.

### BRIEF DESCRIPTION OF THE DRAWINGS

These drawings are for reference only in describing embodiments of the present disclosure, and therefore the technical idea of the present disclosure should not be limited to the accompanying drawings.

FIG. 1 illustrates a perspective view of an axial flux motor according to an embodiment.

FIG. 2 illustrates an exploded perspective view of an axial flux motor according to an embodiment.

FIG. 3 illustrates a perspective view of a stator printed circuit board (PCB) pattern of an axial flux motor according to an embodiment.

FIG. 4 illustrates a perspective view of one of a U-phase coil, a V-phase coil, and a W-phase coil of a stator PCB pattern according to a first embodiment.

FIG. 5 illustrates a top plan view of one of a U-phase coil, a V-phase coil, and a W-phase coil of a stator PCB pattern according to a first embodiment.

FIG. 6 and FIG. 7 illustrate partial perspective views of an enlarged portion of one of a U-phase coil, a V-phase coil, and a W-phase coil of a stator PCB pattern according to a first embodiment.

FIG. 8 is a diagram for explaining the current flow of a stator PCB pattern according to a first embodiment.

FIG. 9 illustrates a perspective view of one of a U-phase coil, a V-phase coil, and a W-phase coil of a stator PCB pattern according to a second embodiment.

FIG. 10 illustrates a top plan view of one of a U-phase coil, a V-phase coil, and a W-phase coil of a stator PCB pattern according to a second embodiment.

FIG. 11 and FIG. 12 illustrate partial perspective views of an enlarged portion of one of a U-phase coil, a V-phase coil, and a W-phase coil of a stator PCB pattern according to a second embodiment.

FIG. 13 is a diagram for explaining the current flow of a stator PCB pattern according to a second embodiment.

FIG. 14 illustrates a perspective view of one of a U-phase coil, a V-phase coil, and a W-phase coil of a stator PCB pattern according to a third embodiment.

FIG. 15 illustrates a top plan view of one of a U-phase coil, a V-phase coil, and a W-phase coil of a stator PCB pattern according to a third embodiment.

FIG. 16 and FIG. 17 illustrate partial perspective views of an enlarged portion of one of a U-phase coil, a V-phase coil, and a W-phase coil of a stator PCB pattern according to a third embodiment.

FIG. 18 is a diagram for explaining the current flow of a stator PCB pattern according to a third embodiment.

FIG. 19 illustrates a perspective view of one of a U-phase coil, a V-phase coil, and a W-phase coil of a stator PCB pattern according to a fourth embodiment.

FIG. 20 illustrates a top plan view of one of a U-phase coil, a V-phase coil, and a W-phase coil of a stator PCB pattern according to a fourth embodiment.

FIG. 21 and FIG. 22 illustrate partial perspective views of an enlarged portion of one of a U-phase coil, a V-phase coil, and a W-phase coil of a stator PCB pattern according to a fourth embodiment.

FIG. 23 is a diagram for explaining the current flow of a stator PCB pattern according to a fourth embodiment.

It should be understood that the above-referenced drawings are not necessarily to scale and may present a somewhat simplified representation of various features illustrating the basic principles of the present disclosure. The specific design features of the present disclosure, including, for example, specific dimensions, orientations, locations, and shapes, should be determined in part by the particular intended application and use environment.

### DETAILED DESCRIPTION

The terms used herein are for the purpose of describing particular embodiments only and are not intended to limit the present disclosure. The singular forms “a,” “an,” and “the” are intended to include the plural forms as well, unless the context clearly indicates otherwise. The terms “include” and/or “including” and “comprise” and/or “comprising” specify the presence of the mentioned characteristics, integers, steps, operations, constituent elements, and/or components when used in the present disclosure. However, it should be also understood that the terms do not exclude the presence or addition of one or more of other characteristics, integers, steps, operations, constituent elements, components, and/or groups thereof. The term “and/or” includes any one or all combinations of the associated and listed items.

The present disclosure is described more fully hereinafter with reference to the accompanying drawings, in which embodiments of the present disclosure are shown. However, those having ordinary skill in the art should realize that the described embodiments may be modified in various different ways, all without departing from the spirit or scope of the only and present disclosure.

In order to clearly describe the present disclosure, parts or portions that are irrelevant to the description are omitted, and identical or similar constituent elements throughout the present disclosure are denoted by the same reference numerals.

In addition, because the size and thickness of each configuration shown in the drawings are arbitrarily shown for convenience of description, the present disclosure is not necessarily limited to configurations illustrated in the drawings. In order to clearly illustrate several parts and areas, enlarged thicknesses are shown.

The terms “module” and/or “unit, portion, or part” representing constituent element used in the following description are used only in order to make understanding of the specification easier. Thus, these terms do not have meanings or roles that distinguish them from each other by themselves.

In addition, in describing embodiments, when it is determined that a detailed description of the well-known art associated with the present disclosure may obscure the gist of the present disclosure, it has been omitted.

In addition, the accompanying drawings are provided only in order to allow embodiments disclosed in the present disclosure to be easily understood and should not be interpreted as limiting the spirit disclosed in the present disclosure. It should be understood that the present disclosure includes all modifications, equivalents, and substitutions without departing from the scope and spirit of the present disclosure.

Terms including an ordinal number, such as first, second, etc., may be used to describe various elements, but the elements are not limited by the terms.

In the description below, a singular form may be intended to include a plural form as well, unless an explicit expression such as “one” or “single” is used.

These terms are only used to differentiate one constituent element from another. When a controller, apparatus, module, component, device, element, or the like of the present disclosure is described as having a purpose or performing an operation, function, or the like, the controller, apparatus, module, component, device, element, or the like should be considered herein as being “configured to” meet that purpose or to perform that operation or function. Each controller, apparatus, module, component, device, element, and the like may separately embody or be included with a processor and a memory, such as a non-transitory computer readable media, as part of the apparatus.

Hereinafter, an axial flux motor according to an embodiment is described in detail with reference to the accompanying drawings.

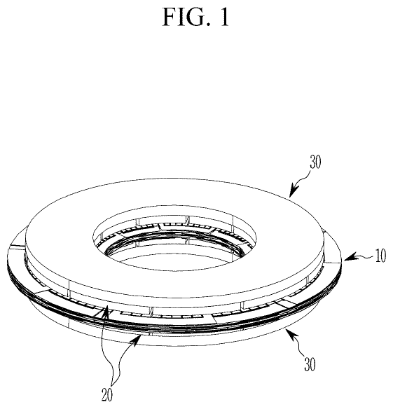

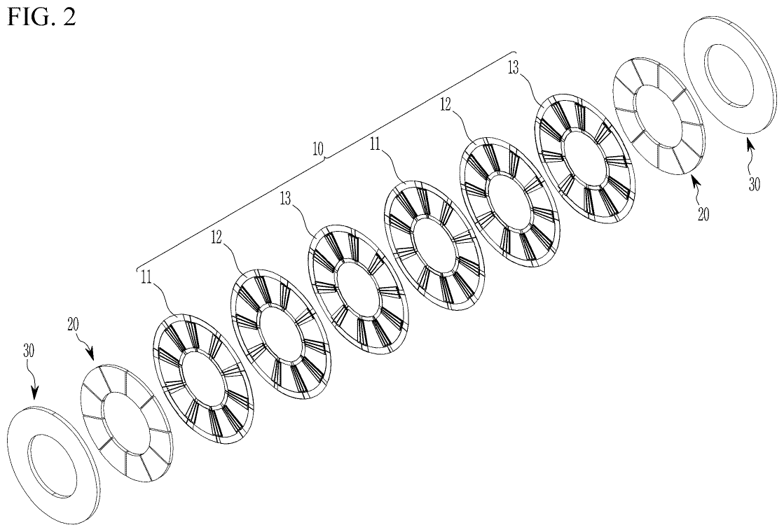

FIG. 1 illustrates a perspective view of an axial flux motor according to an embodiment. FIG. 2 illustrates an exploded perspective view of an axial flux motor according to an embodiment.

As shown in FIG. 1 and FIG. 2, an axial flux motor according to an embodiment may include a stator printed circuit board (PCB) pattern 10, permanent magnets 20 disposed on both sides of the stator PCB pattern 10, and rotor cores 30 disposed on both sides of the permanent magnet 20.

The stator PCB pattern 10 may have stator coils wound in a distributed winding form on a printed circuit board (PCB) 15. The stator coil wound around the stator PCB pattern 10 may include a U-phase coil 11, a V-phase coil 12, and a W-phase coil 13.

The structure of the stator coil is described in detail below.

The permanent magnets 20 disposed on both sides of an axial direction of the stator PCB pattern 10 may be formed in a ring shape by alternately disposing a plurality of permanent magnets 20 with different polarities along a circumferential direction.

The rotor cores 30 disposed on both sides of the axial direction of the permanent magnet 20 may be formed in a ring shape.

When a current is supplied to the printed circuit board 15 and the current flows through the U-phase coil 11, the V-phase coil 12, and the W-phase coil 13, the rotor core 30 rotates and generates torque due to electromagnetic induction of the permanent magnet 20 and the stator coil.

Hereinafter, a stator coil according to a first embodiment is described in detail with reference to the accompanying drawings.

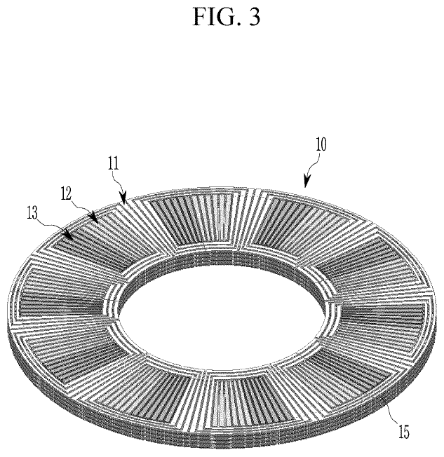

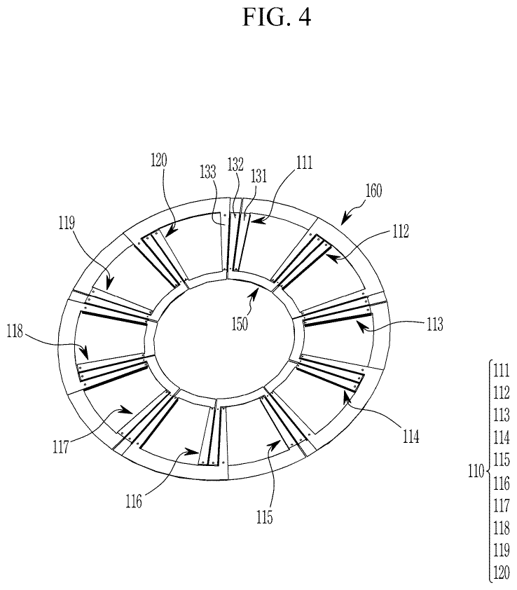

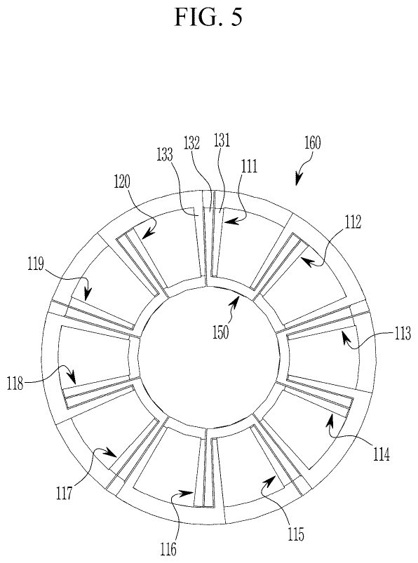

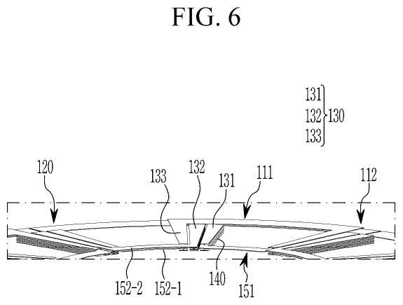

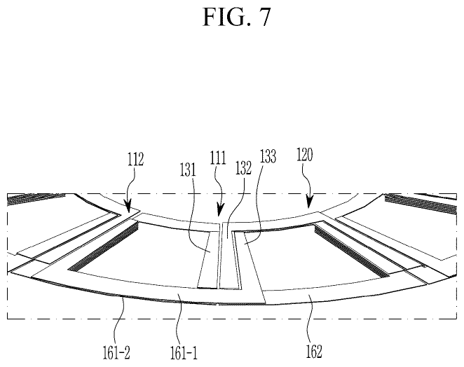

FIG. 3 illustrates a perspective view of the stator PCB pattern 10 of an axial flux motor according to the first embodiment. FIG. 4 illustrates a perspective view of one of the U-phase coil 11, the V-phase coil 12, and the W-phase coil 13 of the stator according to the first embodiment. FIG. 5 illustrates a top plan view of one of the U-phase coil 11, the V-phase coil 12, and the W-phase coil 13 of the stator according to the first embodiment. FIG. 6 and FIG. 7 illustrate partial perspective views of an enlarged portion of one of the U-phase coil 11, the V-phase coil 12, and the W-phase coil 13 of the stator according to the first embodiment.

Referring to FIG. 3 to FIG. 7, the U-phase coil 11, the V-phase coil 12, and the W-phase coil 13 may be wound on both sides of the printed circuit board 15, respectively, and the U-phase coil 11, the V-phase coil 12, and the W-phase coil 13 may be sequentially disposed along the circumferential direction.

In other words, the U-phase coil 11, the V-phase coil 12, and the W-phase coil 13 may be sequentially disposed along the circumferential direction, and another U-phase coil 11, another V-phase coil 12, and another W-phase coil 13 may be sequentially arranged along the circumferential direction. In this way, the U-phase coil 11, the V-phase coil 12, and the W-phase coil 13 are sequentially disposed along the circumferential direction, so that the stator coil of the stator PCB pattern 10 may form a ring shape.

Each of the U-phase coil 11, the V-phase coil 12, and the W-phase coil 13 may be wound in the same shape.

Each of the U-phase coil 11, the V-phase coil 12, and the W-phase coil 13 of the stator coil may include a plurality of main mid-turn assemblies 110 disposed at set intervals along the circumferential direction and may include a plurality of end turns electrically connecting the main mid-turn assemblies 110 adjacent to each other inside and outside the radial direction, respectively.

The main mid-turn assembly 110 may include a plurality of auxiliary mid-turn assemblies 130 disposed along the circumferential direction, and each of the auxiliary mid-turn assemblies 130 may include a plurality of mid-turns disposed in parallel along the axial direction.

In the first embodiment, the main mid-turn assembly 110 may include a first main mid-turn assembly 111 to a tenth main mid-turn assembly 120 disposed along the circumferential direction. Each of the main mid-turn assemblies 111 to 120 may include three auxiliary mid-turn assemblies 130 (a first auxiliary mid-turn assembly 131, a second auxiliary mid-turn assembly 132, and a third auxiliary mid-turn assembly 133) disposed along the circumferential direction, and each of the auxiliary mid-turn assemblies 131 to 133 may include six mid-turns (first to sixth mid-turns) disposed along the axial direction.

Spaces between respective mid-turns of the auxiliary mid-turn assemblies 130 disposed in parallel along the axial direction may be spaced apart from each other so that a via hole may be formed.

In the first embodiment, the main mid-turn assembly 110 of the V-phase coil 12 may be disposed adjacent to the main mid-turn assembly 110 of the U-phase coil 11 in the circumferential direction, and the main mid-turn assembly 110 of the W-phase coil 13 may be disposed adjacent to the circumferential direction of the V-phase coil 12. In this way, the main mid-turn assemblies 110 of the U-phase coil 11, the V-phase coil 12, and the W-phase coil 13 are arranged in the circumferential direction so that the stator coils 11, 12, and 13 of the stator PCB pattern 10 may be formed in a ring shape.

The end turn may include a plurality of inner end turns 150 positioned radially inside the main mid-turn assembly 110 and formed in an arc shape, and a plurality of outer end turns 160 positioned radially outside the main mid-turn assembly 110 and formed in an arc shape.

The inner end turn 150 may electrically connect the main mid-turn assemblies (the second main mid-turn assembly 112 and the tenth main mid-turn assembly 120) respectively adjacent to one side and the other side of the circumferential direction of the main mid-turn assembly (the first main mid-turn assembly 111).

The inner end turn 150 may include a first inner end turn 151, a (2-1)-th inner end turn 152-1, and a (2-2)-th inner end turn 152-2.

The first inner end turn 151 may electrically connect the main mid-turn assembly (the first main mid-turn assembly 111) and another main mid-turn assembly (the second main mid-turn assembly 112) adjacent to one side in the circumferential direction. In addition, the (2-1)-th inner end turn 152-1 and the (2-2)-the inner end turn 152-2 may electrically connect another main mid-turn assembly (the tenth main mid-turn assembly 120) adjacent to the other side of the circumferential direction.

Specifically, the first inner end turn 151 may electrically connect one mid-turn assembly (the first auxiliary mid-turn assembly 131) of the plurality of auxiliary mid-turn assemblies 130 of the main mid-turn assembly (the first main mid-turn assembly 111) and one mid-turn assembly (the third auxiliary mid-turn assembly 133) of the plurality of auxiliary mid-turn assemblies 130 of another main mid-turn assembly (the second main mid-turn assembly 112) adjacent to one side of the circumferential direction.

The (2-1)-th inner end turn 152-1 may electrically connect the main mid-turn assembly (the first main mid-turn assembly 111) and another main mid-turn assembly (the tenth main mid-turn assembly 120) adjacent to the other side in the circumferential direction.

The (2-1)-th inner end turn 152-1 may electrically connect another auxiliary mid-turn assembly (the third auxiliary mid-turn assembly 133) of the plurality of auxiliary mid-turn assemblies 130 of the main mid-turn assembly (the first main mid-turn assembly 111) and one mid-turn assembly (the first auxiliary mid-turn assembly 131) of the plurality of auxiliary mid-turn assemblies 130 of another main mid-turn assembly (the tenth main mid-turn assembly 120) adjacent to the other side of the circumferential direction.

The (2-2) inner end turn 152-2 may electrically connect the main mid-turn assembly (the first main mid-turn assembly 111) and another main mid-turn assembly (the tenth main mid-turn assembly 120) adjacent to the other side in the circumferential direction. The (2-2)-th inner end turn 152-2 may be disposed above the (2-1)-th inner end turn 152-1 in the axial direction.

The (2-2)-th inner end turn 152-2 may electrically connect another auxiliary mid-turn assembly (the second auxiliary mid-turn assembly 132) of the plurality of auxiliary mid-turn assemblies 130 of the main mid-turn assembly (the first main mid-turn assembly 111) and another mid-turn assembly (the second auxiliary mid-turn assembly 132) of the plurality of auxiliary mid-turn assemblies 130 of another main mid-turn assembly (the tenth main mid-turn assembly 120) adjacent to the other side of the circumferential direction.

The outer end turn 160 may electrically connect the main mid-turn assemblies (the second main mid-turn assembly 112 and the tenth main mid-turn assembly 120) respectively adjacent to one side and the other side of the circumferential direction of the main mid-turn assembly (the first main mid-turn assembly 111).

The outer end turn 160 may include a (1-1)-th outer end turn 161-1, a (1-2)-th outer end turn 161-2, and a second outer end turn 162.

The (1-1)-th outer end turn 161-1 and the (1-2)-th outer end turn 161-2 may electrically connect the main mid-turn assembly (the first main mid-turn assembly 111) and another main mid-turn assembly (the second main mid-turn assembly 112) adjacent to one side in the circumferential direction. In addition, the second outer end turn 162 may electrically connect the main mid-turn assembly (the first main mid-turn assembly 111) and another main mid-turn assembly (the tenth main mid-turn assembly 120) adjacent to the other side in the circumferential direction.

The (1-1)-th outer end turn 161-1 may electrically connect the main mid-turn assembly (the first main mid-turn assembly 111) and another main mid-turn assembly (the second main mid-turn assembly 112) adjacent to one side in the circumferential direction.

Specifically, the (1-1)-th outer end turn 161-1 may electrically connect one mid-turn assembly (the third auxiliary mid-turn assembly 133) of the plurality of auxiliary mid-turn assemblies 130 of the main mid-turn assembly (the first main mid-turn assembly 111) and another auxiliary mid-turn assembly (the first auxiliary mid-turn assembly 131) of the plurality of auxiliary mid-turn assemblies 130 of another main mid-turn assembly (the second main mid-turn assembly 112) adjacent to one side of the circumferential direction.

The (1-2)-th outer end turn 161-2 may electrically connect the main mid-turn assembly (the first main mid-turn assembly 111) and another main mid-turn assembly (the second main mid-turn assembly 112) adjacent to one side in the circumferential direction. The (1-2)-th outer end turn 161-2 may be disposed below the (1-1)-th outer end turn 161-1 in the axial direction.

Specifically, the (1-2)-th outer end turn 161-2 may electrically connect one mid-turn assembly (the first auxiliary mid-turn assembly) of the plurality of auxiliary mid-turn assemblies of the main mid-turn assembly (the first main mid-turn assembly 111) and another mid-turn assembly (the second auxiliary mid-turn assembly 132) of the plurality of mid-turn assemblies 130 of another main mid-turn assembly (the second main mid-turn assembly 112) adjacent to one side of the circumferential direction.

The second outer end turn 162 may electrically connect the main mid-turn assembly (the first main mid-turn assembly 111) and another main mid-turn assembly (the tenth main mid-turn assembly 120) positioned on the other side in the circumferential direction.

Specifically, the second outer end turn 162 may electrically connect another auxiliary mid-turn assembly (the second auxiliary mid-turn assembly 132) of the plurality of auxiliary mid-turn assemblies 130 of the main mid-turn assembly (the first main mid-turn assembly 111) and one mid-turn assembly (the first auxiliary mid-turn assembly 131) of the plurality of auxiliary mid-turn assemblies 130 of another main mid-turn assembly (the tenth main mid-turn assembly 120) adjacent to the other side of the circumferential direction.

A process of supplying a current to the stator PCB pattern according to the first embodiment is described below.

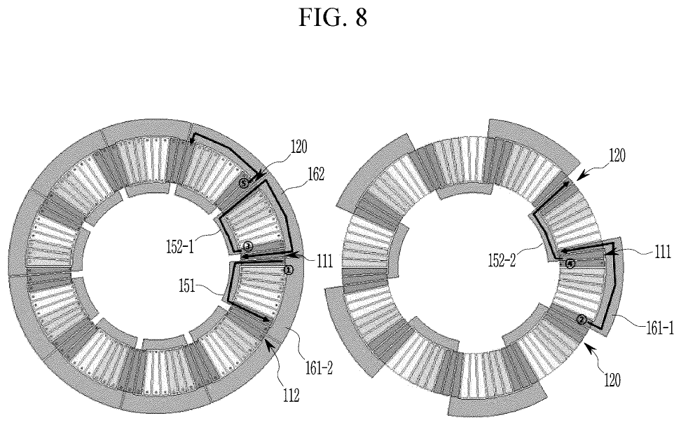

Referring to FIG. 8, a current supplied from a power supply (for example, a battery) flows in the order of one auxiliary mid-turn assembly (the first auxiliary mid-turn assembly 131) of the main mid-turn assembly (the first main mid-turn assembly 111)→the first inner end turn 151→one auxiliary mid-turn assembly (the third auxiliary mid-turn assembly 133) of another main mid-turn assembly (the second main mid-turn assembly 112) adjacent to one side of the circumferential direction of the main mid-turn assembly (the first main mid-turn assembly 111)→the (1-1)-th outer end turn 161-1→another auxiliary mid-turn assembly (the third auxiliary mid-turn assembly 133) of the main mid-turn assembly (the first main mid-turn assembly 111)→the (2-1)-the inner end turn 152-1→one auxiliary mid-turn assembly (the first auxiliary mid-turn assembly 131) of another main mid-turn assembly (the tenth main mid-turn assembly 120) adjacent to the other side of the circumferential direction of the main mid-turn assembly (the first main mid-turn assembly 111)→the second outer end turn 162→another auxiliary mid-turn assembly (the third auxiliary mid-turn assembly 133) of the main mid-turn assembly 110)→the (2-2)-the inner end turn 152-2.

By supplying the current in this order, all coil turns are connected in series, eliminating the need for additional unnecessary coil wiring design, and thus eliminating the need for securing separate space for additional wiring. Accordingly, it is possible to increase the utilization of the space in which the end turns are disposed.

In addition, because it is possible to design the end turns thick, the current density may be alleviated when the current flowing in the effective conductors scattered in the auxiliary mid-turn assemblies 130 disposed in parallel converges in the end turns.

Hereinafter, the stator PCB pattern 10 according to the second embodiment is described in detail with reference to the accompanying drawings.

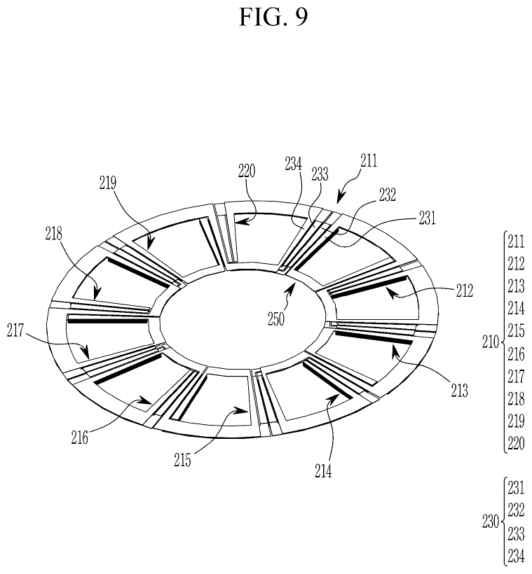

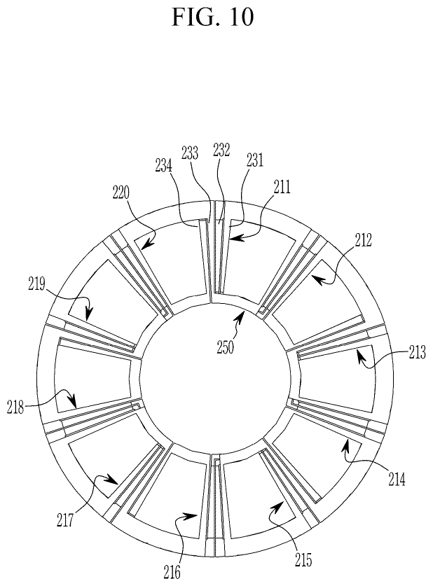

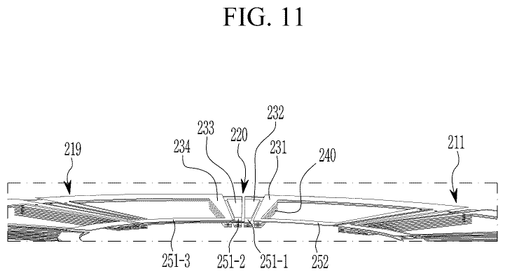

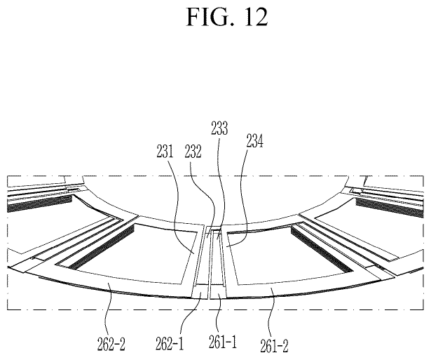

FIG. 9 illustrates a perspective view of one of a U-phase coil 11, a V-phase coil 12, and a W-phase coil 13 of the stator according to the second embodiment. FIG. 10 illustrates a top plan view of one of the U-phase coil 11, the V-phase coil 12, and the W-phase coil 13 of the stator according to the second embodiment. FIG. 11 and FIG. 12 illustrate partial perspective views of an enlarged portion of one of the U-phase coil 11, the V-phase coil 12, and the W-phase coil 13 of the stator according to the second embodiment.

Referring to FIG. 9 to FIG. 12, as in the stator coils described with reference to FIG. 3 to FIG. 7, the U-phase coil 11, the V-phase coil 12, and the W-phase coil 13 may be disposed on both sides of the printed circuit board 15, respectively, and the U-phase coil 11, the V-phase coil 12, and the W-phase coil 13 may be sequentially disposed along the circumferential direction.

Hereinafter, the stator coil is described with a focus on the parts that are different from those in FIG. 3 to FIG. 7.

In the second embodiment, the main mid-turn assembly 210 may include first to tenth main mid-turn assemblies 211 to 220 along the circumferential direction, each main mid-turn assembly 210 may include four auxiliary mid-turn 230 assemblies (a first auxiliary mid-turn assembly 231, a second auxiliary mid-turn assembly 232, a third auxiliary mid-turn assembly 233, and a fourth auxiliary mid-turn assembly 234) disposed along the circumferential direction, and each auxiliary mid-turn assembly 230 may include six mid-turns (first to sixth mid-turns) disposed along the axial direction.

Spaces between respective mid-turns of the auxiliary mid-turn assemblies 230 disposed in parallel along the axial direction may be spaced apart from each other so that a via hole may be formed.

In the second embodiment, the main mid-turn assembly 210 of the V-phase coil 12 may be disposed adjacent to the main mid-turn assembly 210 of the U-phase coil 11 in the circumferential direction, and the main mid-turn assembly 210 of the W-phase coil 13 may be disposed adjacent to the circumferential direction of the V-phase coil 12. In this way, the main mid-turn assemblies 210 of the U-phase coil 11, the V-phase coil 12, and the W-phase coil 13 are arranged in the circumferential direction so that the stator PCB pattern 10 may be formed in a ring shape.

The end turn may include at least one inner end turn 250 positioned radially inside the main mid-turn assembly 210 and formed in an arc shape, and at least one outer end turn 260 positioned radially outside the main mid-turn assembly 210 and formed in an arc shape.

The inner end turn 250 may electrically connect the main mid-turn assembly (the first main mid-turn assembly 211) and another main mid-turn assembly (the tenth main mid-turn assembly 220) adjacent to one side of circumferential direction of the main mid-turn assembly (the first main mid-turn assembly 211). The inner end turn 250 may electrically connect another main mid-turn assembly (the tenth main mid-turn assembly 220) and another main mid-turn assembly (the ninth main mid-turn assembly 219) adjacent to one side of the circumferential direction of another main mid-turn assembly 220.

The inner end turn 250 may include a (1-1)-th inner end turn 251-1, a (1-2)-th inner end turn 251-2, a (1-3)-th inner end turn 251-3, and a second inner end turn 252.

The (1-1)-th inner end turn 251-1, the (1-2)-th inner end turn 251-2, and the (1-3)-th inner end turn 251-3 may electrically connect the main mid-turn assembly (the first main mid-turn assembly 211) and another main mid-turn assembly (the second main mid-turn assembly 212) adjacent to one side in the circumferential direction. In addition, the second inner end turn 252 may electrically connect another main mid-turn assembly (the second main mid-turn assembly 212) and another main mid-turn assembly (the ninth main mid-turn assembly 219) adjacent to one side in the circumferential direction.

Specifically, the (1-1)-th inner end turn 251-1 may electrically connect one auxiliary mid-turn assembly (the second auxiliary mid-turn assembly 232) of the main mid-turn assembly (the first main mid-turn assembly 211) and one auxiliary mid-turn assembly (the second auxiliary mid-turn assembly 232) of another main mid-turn assembly (the second main mid-turn assembly 212) adjacent to one side of the circumferential direction of the main mid-turn assembly (the first main mid-turn assembly 211).

The (1-2)-th inner end turn 251-2 may electrically connect another auxiliary mid-turn assembly (the third auxiliary mid-turn assembly 233) of the main mid-turn assembly (the first main mid-turn assembly 211) and another auxiliary mid-turn assembly (the first auxiliary mid-turn assembly 231) of another main mid-turn assembly (the second main mid-turn assembly 212) adjacent to one side of the circumferential direction of the main mid-turn assembly (the first main mid-turn assembly 211).

The (1-3)-th inner end turn 251-3 may electrically connect another auxiliary mid-turn assembly (the fourth auxiliary mid-turn assembly 234) of the main mid-turn assembly (the first main mid-turn assembly 211) and another auxiliary mid-turn assembly (the third auxiliary mid-turn assembly 233) of another main mid-turn assembly (the second main mid-turn assembly 212) adjacent to one side of the circumferential direction of the main mid-turn assembly (the first main mid-turn assembly 211).

The second inner end turn 252 may electrically connect one auxiliary mid-turn assembly (the first auxiliary mid-turn assembly 231) of another main mid-turn assembly (the third main mid-turn assembly 213) adjacent to one side of the circumferential direction of another main mid-turn assembly (the second main mid-turn assembly 212) and another auxiliary mid-turn assembly (the fourth auxiliary mid-turn assembly 234) of another main mid-turn assembly (the second main mid-turn assembly 212) adjacent to one side of the circumferential direction of the main mid-turn assembly (the first main mid-turn assembly 211).

The outer end turn 260 may electrically connect the main mid-turn assembly (the first main mid-turn assembly 211) and another main mid-turn assembly (the second main mid-turn assembly 212) adjacent to one side of circumferential direction of the main mid-turn assembly (the first main mid-turn assembly 211). The outer end turn 260 may electrically connect another main mid-turn assembly (the ninth main mid-turn assembly 219) adjacent to one side of the circumferential direction of another main mid-turn assembly (the second main mid-turn assembly 212).

The outer end turn 260 may include a (1-1)-th outer end turn 261-1, a (1-2)-th outer end turn 261-2, a (2-1)-th outer end turn 262-2, and a (2-2)-th outer end turn 262-2.

The (1-1)-th outer end turn 261-1 and the (1-2)-th outer end turn 261-2 may electrically connect the main mid-turn assembly (the first main mid-turn assembly 211) and another main mid-turn assembly (the second main mid-turn assembly 212) adjacent to one side in the circumferential direction. The (2-1)-th outer end turn 262-2 and the (2-2)-th outer end turn 262-2 may electrically connect another main mid-turn assembly (the second main mid-turn assembly 212) and another main mid-turn assembly (the third main mid-turn assembly 213) adjacent to one side in the circumferential direction.

The (1-1)-th outer end turn 261-1 may electrically connect another auxiliary mid-turn assembly (the third auxiliary mid-turn assembly 230) of the main mid-turn assembly (the first main mid-turn assembly 211) and one auxiliary mid-turn assembly (the third auxiliary mid-turn assembly 233) of another main mid-turn assembly (the second main mid-turn assembly 212) adjacent to one side of the circumferential direction of the main mid-turn assembly (the first main mid-turn assembly 211).

The (1-2)-th outer end turn 261-2 may electrically connect another auxiliary mid-turn assembly (the fourth auxiliary mid-turn assembly 234) of the main mid-turn assembly (the first main mid-turn assembly 211) and another auxiliary mid-turn assembly (the first auxiliary mid-turn assembly 231) of another main mid-turn assembly (the tenth main mid-turn assembly 220) adjacent to one side of the circumferential direction of the main mid-turn assembly (the first main mid-turn assembly 211).

The (2-1)-th outer end turn 262-2 may electrically connect another auxiliary mid-turn assembly (the third auxiliary mid-turn assembly 233) of another main mid-turn assembly (the tenth main mid-turn assembly 220) adjacent to one side of the circumferential direction of the main mid-turn assembly (the first main mid-turn assembly 211) and one auxiliary mid-turn assembly (the first auxiliary mid-turn assembly 231) of another main mid-turn assembly (the ninth main mid-turn assembly 219) adjacent to one side of the circumferential direction of another main mid-turn assembly (the tenth main mid-turn assembly 220).

The (2-2)-th outer end turn 262-2 may electrically connect another auxiliary mid-turn assembly (the fourth auxiliary mid-turn assembly 234) of another main mid-turn assembly (the tenth main mid-turn assembly 220) adjacent to one side of the circumferential direction of the main mid-turn assembly (the first main mid-turn assembly 211) and one auxiliary mid-turn assembly (the second auxiliary mid-turn assembly 232) of another main mid-turn assembly (the ninth main mid-turn assembly 219) adjacent to one side of the circumferential direction of another main mid-turn assembly (the tenth main mid-turn assembly 220).

A process of supplying a current to the stator PCB pattern 10 according to the second embodiment is described below.

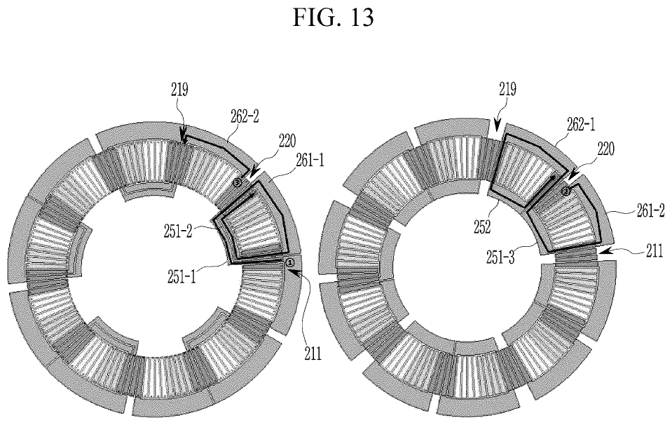

Referring to FIG. 13, a current supplied from a power supply (for example, a battery) flows in the order of one auxiliary mid-turn assembly (the second auxiliary mid-turn assembly 232) of the main mid-turn assembly (the first main mid-turn assembly 211)→the (1-1)-th inner end turn 251-1→one auxiliary mid-turn assembly (the second auxiliary mid-turn assembly 232) of another main mid-turn assembly (the second main mid-turn assembly 212) adjacent to one side of the circumference of the main mid-turn assembly (the first main mid-turn assembly 211)→the (1-1)-th outer end turn 261-1→another auxiliary mid-turn assembly (the third auxiliary mid-turn assembly 233) of the main mid-turn assembly (the first main mid-turn assembly 211)→the (1-2)-the inner end turn 251-2→another auxiliary mid-turn assembly (the first auxiliary mid-turn assembly 231) of another main mid-turn assembly (the second main mid-turn assembly 212) adjacent to one side of the circumference of the main mid-turn assembly (the first main mid-turn assembly 211)→the (1-2)-th outer end turn 261-2→another auxiliary mid-turn assembly (the fourth auxiliary mid-turn assembly 234) of the main mid-turn assembly (the first main mid-turn assembly 211)→the (1-3)-th inner end turn 251-3→another auxiliary mid-turn assembly (the third auxiliary mid-turn assembly 233) of another main mid-turn assembly (the second main mid-turn assembly 212) adjacent to one side of the circumference of the main mid-turn assembly (the first main mid-turn assembly 211)→the (2-1)-th outer end turn 262-1→one auxiliary mid-turn assembly (the first auxiliary mid-turn assembly 231) of another main mid-turn assembly (the third main mid-turn assembly 213) adjacent to one side of the circumference of another main mid-turn assembly (the second main mid-turn assembly 212)→the second inner end turn 252→another auxiliary mid-turn assembly (the fourth auxiliary mid-turn assembly 234) of another main mid-turn assembly (the second main mid-turn assembly 212) adjacent to one side of the circumference of the main mid-turn assembly (the first main mid-turn assembly 211)→the (2-2)-th outer end turn 262-2→one auxiliary mid-turn assembly (the second auxiliary mid-turn assembly 232) of another main mid-turn assembly (the third main mid-turn assembly 213) adjacent to one side of the circumference of another main mid-turn assembly (the second main mid-turn assembly 212).

Hereinafter, the stator PCB pattern 10 according to the third embodiment is described in detail with reference to the accompanying drawings.

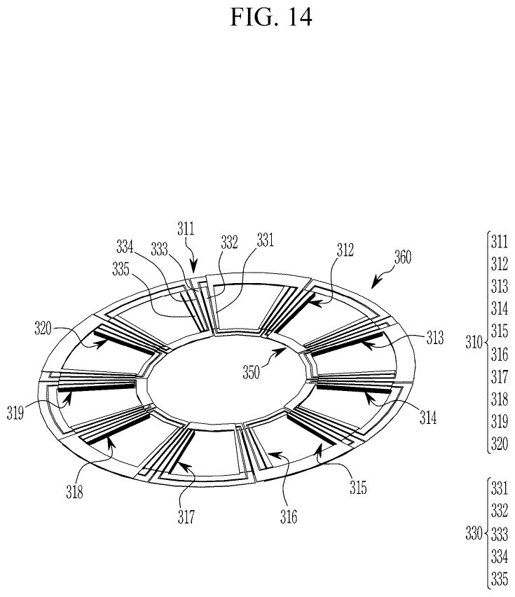

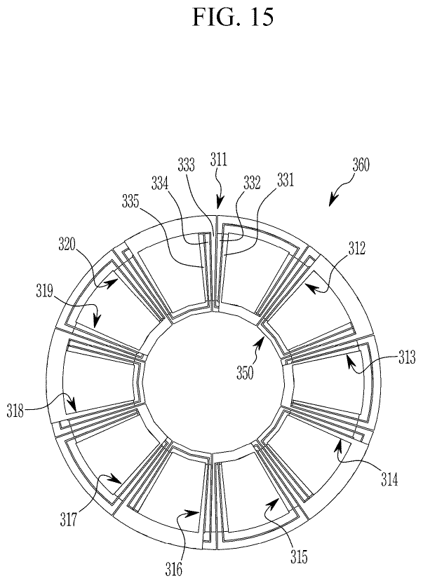

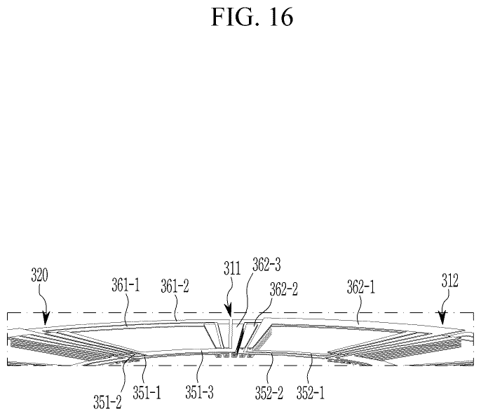

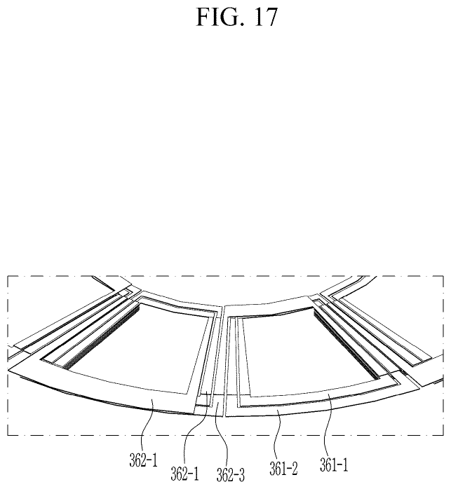

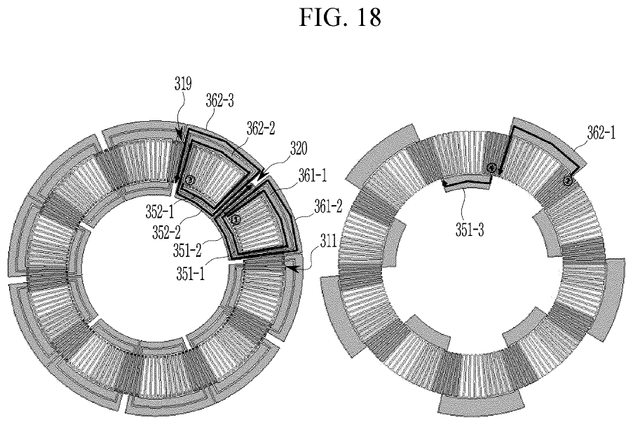

FIG. 14 is a diagram for explaining the current flow of the stator PCB pattern 10 according to the third embodiment. FIG. 15 illustrates a perspective view of one of a U-phase coil, a V-phase coil, and a W-phase coil of the stator PCB pattern according to the third embodiment. FIG. 16 illustrates a top plan view of one of a U-phase coil, a V-phase coil, and a W-phase coil of the stator PCB pattern according to the third embodiment. FIG. 17 and FIG. 18 illustrate partial perspective views of an enlarged portion of one of a U-phase coil, a V-phase coil, and a W-phase coil of the stator PCB pattern according to the third embodiment.

Referring to FIG. 14 to FIG. 17, as in the stator coils described with reference to FIG. 3 to FIG. 7, the U-phase coil 11, the V-phase coil 12, and the W-phase coil 13 may be disposed on both sides of the printed circuit board 15, respectively, and the U-phase coil 11, the V-phase coil 12, and the W-phase coil 13 may be sequentially disposed along the circumferential direction.

Hereinafter, the stator coil is described with a focus on the parts that are different from those in FIG. 3 to FIG. 7.

In the third embodiment, the main mid-turn assembly 310 may include first to tenth main mid-turn assemblies 311 to 320 along the circumferential direction, each main mid-turn assembly 310 may include five auxiliary mid-turn assemblies 330 (a first auxiliary mid-turn assembly 331, a second auxiliary mid-turn assembly 332, a third auxiliary mid-turn assembly 333, a fourth auxiliary mid-turn assembly 334, and a fifth auxiliary mid-turn assembly 335) disposed along the circumferential direction, and each auxiliary mid-turn assembly 330 may include six mid-turns (first to sixth mid-turns) disposed along the axial direction.

Spaces between respective mid-turns of the auxiliary mid-turn assemblies 330 disposed in parallel along the axial direction may be spaced apart from each other so that a via hole may be formed.

In the third embodiment, the main mid-turn assembly 310 of the V-phase coil 12 may be disposed adjacent to the main mid-turn assembly 310 of the U-phase coil 11 in the circumferential direction, and the main mid-turn assembly 310 of the W-phase coil 13 may be disposed adjacent to the circumferential direction of the V-phase coil 12. In this way, the main mid-turn assemblies 310 of the U-phase coil 11, the V-phase coil 12, and the W-phase coil 13 are arranged in the circumferential direction so that the stator PCB pattern 10 may be formed in a ring shape.

The end turn may include at least one inner end turn 350 positioned radially inside the main mid-turn assembly 310 and formed in an arc shape, and at least one outer end turn 360 positioned radially outside the main mid-turn assembly 310 and formed in an arc shape.

The inner end turn 350 may electrically connect the main mid-turn assemblies (the second main mid-turn assembly 312 and the tenth main mid-turn assembly 320) respectively adjacent to one side and the other side of the circumferential direction of the main mid-turn assembly (the first main mid-turn assembly 311).

The inner end turn 350 may include a (1-1)-th inner end turn 351-1, a (1-2)-th inner end turn 351-2, a (1-3)-th inner end turn 351-3, a (2-1)-th inner end turn 352-1, and a (2-2)-th inner end turn 352-2.

The (1-1)-th inner end turn 351-1 to the (1-3)-th inner end turn 351-3 may electrically connect the main mid-turn assembly (the first main mid-turn assembly 311) and another main mid-turn assembly (the second main mid-turn assembly 312) respectively adjacent to one side in the circumferential direction. In addition, the (2-1)-th and (2-2)-th inner end turns 352-2 may electrically connect the main mid-turn assembly (the first main mid-turn assembly 311) and another main mid-turn assembly (the tenth main mid-turn assembly 320) respectively adjacent to the other side in the circumferential direction.

Specifically, the (1-1)-th inner end turn 351-1 may electrically connect one auxiliary mid-turn assembly (the second auxiliary mid-turn assembly 332) of the main mid-turn assembly (the first main mid-turn assembly 311) and one auxiliary mid-turn assembly (the fifth auxiliary mid-turn assembly 335) of another main mid-turn assembly (the second main mid-turn assembly 312) adjacent to one side of the circumferential direction of the main mid-turn assembly (the first main mid-turn assembly 311).

The (1-2)-th inner end turn 351-2 may electrically connect another auxiliary mid-turn assembly (the third auxiliary mid-turn assembly 333) of the main mid-turn assembly (the first main mid-turn assembly 311) and another auxiliary mid-turn assembly (the fourth auxiliary mid-turn assembly 334) of another main mid-turn assembly (the second main mid-turn assembly 312) adjacent to one side of the circumferential direction of the main mid-turn assembly (the first main mid-turn assembly 311).

The (1-3)-th inner end turn 351-3 may electrically connect another auxiliary mid-turn assembly (the first auxiliary mid-turn assembly 331) of the main mid-turn assembly (the first main mid-turn assembly 311) and another auxiliary mid-turn assembly (the third auxiliary mid-turn assembly 333) of another main mid-turn assembly (the second main mid-turn assembly 312) adjacent to one side of the circumferential direction of the main mid-turn assembly (the first main mid-turn assembly 311).

The (2-1)-th inner end turn 352-1 may electrically connect another auxiliary mid-turn assembly (the fifth auxiliary mid-turn assembly 335) of the main mid-turn assembly (the first main mid-turn assembly 311) and one auxiliary mid-turn assembly (the first auxiliary mid-turn assembly 331) of another main mid-turn assembly (the tenth main mid-turn assembly 320) adjacent to the other side of the circumferential direction of the main mid-turn assembly (the first main mid-turn assembly 311).

The (2-2)-th inner end turn 352-2 may electrically connect another auxiliary mid-turn assembly (the fourth auxiliary mid-turn assembly 334) of the main mid-turn assembly (the first main mid-turn assembly 311) and another auxiliary mid-turn assembly (the second auxiliary mid-turn assembly 332) of another main mid-turn assembly (the tenth main mid-turn assembly 320) adjacent to the other side of the circumferential direction of the main mid-turn assembly (the first main mid-turn assembly 311).

The outer end turn 360 may electrically connect the main mid-turn assemblies (the second main mid-turn assembly 312 and the tenth main mid-turn assembly 320) adjacent to one side and the other side of the circumferential direction of the main mid-turn assembly (the first main mid-turn assembly 311).

The outer end turn 360 may include a (1-1)-th outer end turn 361-1, a (1-2)-th outer end turn 361-2, a (2-1)-th outer end turn 362-1, a (2-2)-th outer end turn 362-2, and a (2-3)-th outer end turn 362-3.

The (1-1)-th outer end turn 361-1 and the (1-2)-th outer end turn 361-2 may electrically connect the main mid-turn assembly (the first main mid-turn assembly 311) and another main mid-turn assembly (the second main mid-turn assembly 312) adjacent to one side in the circumferential direction. In addition, the (2-1)-th outer end turn 362-2 to the (2-3)-th outer end turn 362-3 may electrically connect the main mid-turn assembly (the first main mid-turn assembly 311) and another main mid-turn assembly (the tenth main mid-turn assembly 320) adjacent to the other side in the circumferential direction.

Specifically, the (1-1)-th outer end turn 361-1 may electrically connect one auxiliary mid-turn assembly (the first auxiliary mid-turn assembly 331) of the main mid-turn assembly (the first main mid-turn assembly 311) and one auxiliary mid-turn assembly (the fifth auxiliary mid-turn assembly 335) of another main mid-turn assembly (the second main mid-turn assembly 312) adjacent to one side of the circumferential direction of the main mid-turn assembly (the first main mid-turn assembly 311).

The (1-2)-th outer end turn 361-2 may electrically connect another auxiliary mid-turn assembly (the second auxiliary mid-turn assembly 332) of the main mid-turn assembly (the first main mid-turn assembly 311) and another auxiliary mid-turn assembly (the fourth auxiliary mid-turn assembly 334) of another main mid-turn assembly (the second main mid-turn assembly 312) adjacent to one side of the circumferential direction of the main mid-turn assembly (the first main mid-turn assembly 311).

The (2-1)-th outer end turn 362-1 may electrically connect another auxiliary mid-turn assembly (the third auxiliary mid-turn assembly 333) of the main mid-turn assembly (the first main mid-turn assembly 311) and one auxiliary mid-turn assembly (the first auxiliary mid-turn assembly 331) of another main mid-turn assembly (the tenth main mid-turn assembly 320) adjacent to the other side of the circumferential direction of the main mid-turn assembly (the first main mid-turn assembly 311).

The (2-2)-th outer end turn 362-2 may electrically connect another auxiliary mid-turn assembly (the fifth auxiliary mid-turn assembly 335) of the main mid-turn assembly (the first main mid-turn assembly 311) and another auxiliary mid-turn assembly (the second auxiliary mid-turn assembly 332) of another main mid-turn assembly (the tenth main mid-turn assembly 320) adjacent to the other side of the circumferential direction of the main mid-turn assembly (the first main mid-turn assembly 311).

The (2-3)-th outer end turn 362-3 may electrically connect another auxiliary mid-turn assembly (the fourth auxiliary mid-turn assembly 334) of the main mid-turn assembly (the first main mid-turn assembly 311) and another auxiliary mid-turn assembly (the third auxiliary mid-turn assembly 333) of another main mid-turn assembly (the tenth main mid-turn assembly 320) adjacent to the other side of the circumferential direction of the main mid-turn assembly (the first main mid-turn assembly 311).

A process of supplying a current to the stator PCB pattern 10 according to the third embodiment is described below.

Referring to FIG. 18, a current supplied from a power supply (for example, a battery) flows in the order of one auxiliary mid-turn assembly (the first auxiliary mid-turn assembly 331) of the main mid-turn assembly (the first main mid-turn assembly 311)→the (1-1)-th outer end turn 361-1→one auxiliary mid-turn assembly (the fifth auxiliary mid-turn assembly 335) of another main mid-turn assembly (the second main mid-turn assembly 312) adjacent to one side of the circumferential direction of the main mid-turn assembly (the first main mid-turn assembly 311)→the (1-1)-th inner end turn 351-1→another auxiliary mid-turn assembly (the second auxiliary mid-turn assembly 332) of the main mid-turn assembly (the first main mid-turn assembly 311)→the (1-2)-th outer end turn 361-2→another auxiliary mid-turn assembly (the fourth auxiliary mid-turn assembly 334) of another main mid-turn assembly (the second main mid-turn assembly 312) adjacent to one side of the circumferential direction of the main mid-turn assembly (the first main mid-turn assembly 311)→the (1-2)-th inner end turn 351-2→another auxiliary mid-turn assembly (the third auxiliary mid-turn assembly 333) of the main mid-turn assembly (the first main mid-turn assembly 311)→the (2-1)-th outer end turn 362-1→one auxiliary mid-turn assembly (the first auxiliary mid-turn assembly 331) of another main mid-turn assembly (the tenth main mid-turn assembly 320) adjacent to the other side of the circumferential direction of the main mid-turn assembly (the first main mid-turn assembly 311)→the (2-1)-th inner end turn 352-1→another auxiliary mid-turn assembly (the fifth auxiliary mid-turn assembly 335) of the main mid-turn assembly (the first main mid-turn assembly 311)→the (2-2)-th outer end turn 362-2→another auxiliary mid-turn assembly (the second auxiliary mid-turn assembly 332) of another main mid-turn assembly (the tenth main mid-turn assembly 320) adjacent to the other side of the circumferential direction of the main mid-turn assembly (the first main mid-turn assembly 311)→the (2-2)-th outer end turn 352-2→another auxiliary mid-turn assembly (the fourth auxiliary mid-turn assembly 334) of the main mid-turn assembly (the first main mid-turn assembly 311)→the (2-3)-th outer end turn 362-3→another auxiliary mid-turn assembly (the third auxiliary mid-turn assembly 333) of another main mid-turn assembly (the tenth main mid-turn assembly 320) adjacent to the other side of the circumferential direction of the main mid-turn assembly (the first main mid-turn assembly 311).

Hereinafter, the stator PCB pattern 10 according to the fourth embodiment is described in detail with reference to the accompanying drawings.

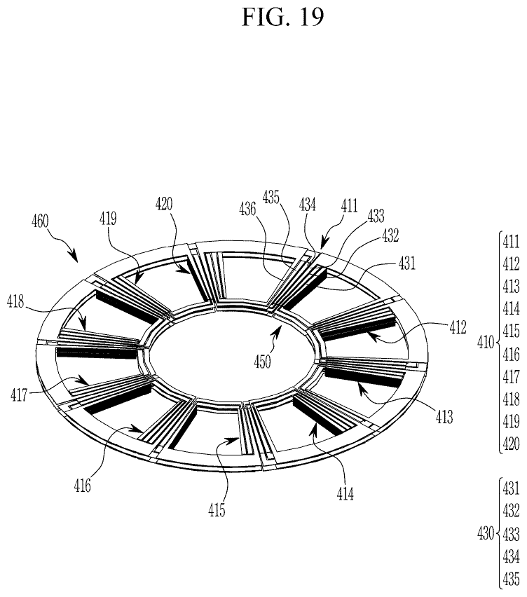

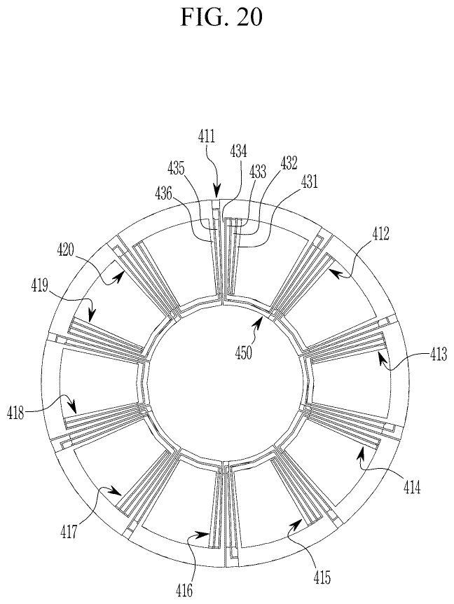

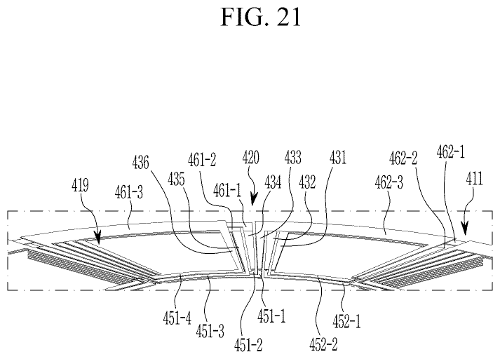

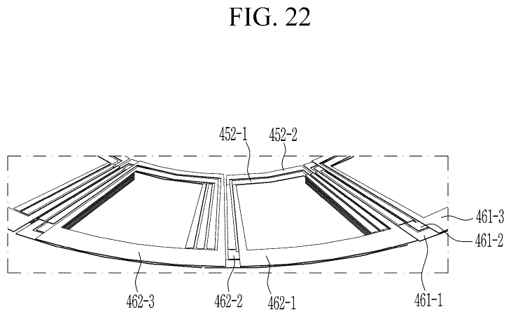

FIG. 19 illustrates a perspective view of one of a U-phase coil, a V-phase coil, and a W-phase coil of the stator PCB pattern according to the fourth embodiment. FIG. 20 illustrates a top plan view of one of a U-phase coil, a V-phase coil, and a W-phase coil of the stator PCB pattern according to the fourth embodiment. FIG. 21 and FIG. 22 illustrate partial perspective views of an enlarged portion of one of a U-phase coil, a V-phase coil, and a W-phase coil of the stator PCB pattern according to the fourth embodiment.

Referring to FIG. 19 to FIG. 22, as in the stator coils described with reference to FIG. 3 to FIG. 7, the U-phase coil 11, the V-phase coil 12, and the W-phase coil 13 may be disposed on both sides of the printed circuit board 15, respectively, and the U-phase coil 11, the V-phase coil 12, and the W-phase coil 13 may be sequentially disposed along the circumferential direction.

Hereinafter, the stator coil is described with a focus on the parts that are different from those in FIG. 3 to FIG. 7.

In the fourth embodiment, the main mid-turn assembly 410 may include first to tenth main mid-turn assemblies 411 to 420 along the circumferential direction, each main mid-turn assembly 410 may include five auxiliary mid-turn assemblies 430 (a first auxiliary mid-turn assembly 431, a second auxiliary mid-turn assembly 432, a third auxiliary mid-turn assembly 433, a fourth auxiliary mid-turn assembly 434, a fifth auxiliary mid-turn assembly 435, and a sixth auxiliary mid-turn assembly 436) disposed along the circumferential direction, and each auxiliary mid-turn assembly 430 may include six mid-turns (first to sixth mid-turns) disposed along the axial direction.

Spaces between respective mid-turns of the auxiliary mid-turn assemblies 430 disposed in parallel along the axial direction may be spaced apart from each other so that a via hole may be formed.

In the fourth embodiment, the main mid-turn assembly 410 of the V-phase coil 12 may be disposed adjacent to the main mid-turn assembly 410 of the U-phase coil 11 in the circumferential direction, and the main mid-turn assembly 410 of the W-phase coil 13 may be disposed adjacent to the circumferential direction of the V-phase coil 12. In this way, the main mid-turn assemblies 410 of the U-phase coil 11, the V-phase coil 12, and the W-phase coil 13 are arranged in the circumferential direction so that the stator PCB pattern 10 may be formed in a ring shape.

The end turn may include at least one inner end turn 450 positioned radially inside the main mid-turn assembly 410 and formed in an arc shape, and at least one outer end turn 460 positioned radially outside the main mid-turn assembly 410 and formed in an arc shape.

The inner end turn 450 may electrically connect the main mid-turn assembly (the first main mid-turn assembly 411) and another main mid-turn assembly (the tenth main mid-turn assembly 420) adjacent to one side of circumferential direction of the main mid-turn assembly (the first main mid-turn assembly 411). The inner end turn 450 may electrically connect another main mid-turn assembly (the tenth main mid-turn assembly 420) and another main mid-turn assembly (the ninth main mid-turn assembly 419) adjacent to one side of the circumferential direction of another main mid-turn assembly 410.

The inner end turn 450 may include a (1-1)-th inner end turn 451-1, a (1-2)-th inner end turn 451-2, a (1-3)-th inner end turn 451-3, a (1-4)-th inner end turn 451-4, a (2-1)-th inner end turn 452-1, and a (2-2)-th inner end turn 452-2.

The (1-1)-th inner end turn 451-1 to the (1-4)-th inner end turn 451-4 may electrically connect the main mid-turn assembly (the first main mid-turn assembly 411) and another main mid-turn assembly (the tenth main mid-turn assembly 420) adjacent to one side in the circumferential direction. In addition, the (2-1)-th inner end turn 452-1 and the (2-2)-th inner end turn 452-2 may electrically connect another main mid-turn assembly (the tenth main mid-turn assembly 420) adjacent to one side of the circumferential direction of the main mid-turn assembly (the first main mid-turn assembly 411), and another main mid-turn assembly (the ninth main mid-turn assembly 419) adjacent to one side of the circumferential direction of another main mid-turn assembly (the tenth main mid-turn assembly 420).

Specifically, the (1-1)-th inner end turn 451-1 may electrically connect one auxiliary mid-turn assembly (the third auxiliary mid-turn assembly 433) of the main mid-turn assembly (the first main mid-turn assembly 411) and one auxiliary mid-turn assembly (the second auxiliary mid-turn assembly 432) of another main mid-turn assembly (the tenth main mid-turn assembly 420) adjacent to one side of the circumferential direction of the main mid-turn assembly (the first main mid-turn assembly 411).

The (1-2)-th inner end turn 451-2 may electrically connect another auxiliary mid-turn assembly (the fourth auxiliary mid-turn assembly 434) of the main mid-turn assembly (the first main mid-turn assembly 411) and another auxiliary mid-turn assembly (the first auxiliary mid-turn assembly 431) of another main mid-turn assembly (the tenth main mid-turn assembly 420) adjacent to one side of the circumferential direction of the main mid-turn assembly (the first main mid-turn assembly 411).

The (1-3)-th inner end turn 451-3 may electrically connect another auxiliary mid-turn assembly (the fifth auxiliary mid-turn assembly 435) of the main mid-turn assembly (the first main mid-turn assembly 411) and another auxiliary mid-turn assembly (the fourth auxiliary mid-turn assembly 434) of another main mid-turn assembly (the tenth main mid-turn assembly 420) adjacent to one side of the circumferential direction of the main mid-turn assembly (the first main mid-turn assembly 411).

The (1-4)-th inner end turn 451-4 may electrically connect another auxiliary mid-turn assembly (the sixth auxiliary mid-turn assembly 436) of the main mid-turn assembly (the first main mid-turn assembly 411) and another auxiliary mid-turn assembly (the third auxiliary mid-turn assembly 433) of another main mid-turn assembly (the tenth main mid-turn assembly 420) adjacent to one side of the circumferential direction of the main mid-turn assembly (the first main mid-turn assembly 411).

The (2-1)-th inner end turn 452-1 may electrically connect another auxiliary mid-turn assembly (the fifth auxiliary mid-turn assembly 435) of another main mid-turn assembly (the tenth main mid-turn assembly 420) adjacent to one side of the circumferential direction of the main mid-turn assembly (the first main mid-turn assembly 411) and one auxiliary mid-turn assembly (the second auxiliary mid-turn assembly 432) of another main mid-turn assembly (the ninth main mid-turn assembly 419) adjacent to one side of the circumferential direction of another main mid-turn assembly (the tenth main mid-turn assembly 420).

The (2-2)-th inner end turn 452-2 may electrically connect another auxiliary mid-turn assembly (the sixth auxiliary mid-turn assembly 436) of another main mid-turn assembly (the tenth main mid-turn assembly 420) adjacent to one side of the circumferential direction of the main mid-turn assembly (the first main mid-turn assembly 411) and another auxiliary mid-turn assembly (the first auxiliary mid-turn assembly 431) of another main mid-turn assembly (the ninth main mid-turn assembly 419) adjacent to one side of the circumferential direction of another main mid-turn assembly (the tenth main mid-turn assembly 420).

The outer end turn 460 may electrically connect another main mid-turn assembly (the tenth main mid-turn assembly 420) adjacent to one side of the circumferential direction of the main mid-turn assembly (the first main mid-turn assembly 411), and another main mid-turn assembly (the ninth main mid-turn assembly 419) adjacent to one side of the circumferential direction of another main mid-turn assembly (the tenth main mid-turn assembly 420).

The outer end turn 460 may include a (1-1)-th outer end turn 461-1, a (1-2)-th outer end turn 461-2, a (1-3)-th outer end turn 461-3, a (2-1)-th outer end turn 462-1, a (2-2)-th outer end turn 462-2, and a (2-3)-th outer end turn 462-3.

The (1-1)-th inner end turn 451-1 to the (1-3)-th outer end turn 461-3 may electrically connect the main mid-turn assembly (the first main mid-turn assembly 411) and another main mid-turn assembly (the tenth main mid-turn assembly 420) adjacent to one side in the circumferential direction. In addition, the (2-1)th outer end turn 462-1 to the (2-3)-th outer end turn 462-3 may electrically connect another main mid-turn assembly (the tenth main mid-turn assembly 420) adjacent to one side of the circumferential direction of the main mid-turn assembly (the first main mid-turn assembly 411), and another main mid-turn assembly (the ninth main mid-turn assembly 419) adjacent to one side of the circumferential direction of another main mid-turn assembly (the tenth main mid-turn assembly 420).

Specifically, the (1-1)-th outer end turn 461-1 may electrically connect another auxiliary mid-turn assembly (the fourth auxiliary mid-turn assembly 434) of the main mid-turn assembly (the first main mid-turn assembly 411) and one auxiliary mid-turn assembly (the second auxiliary mid-turn assembly 432) of another main mid-turn assembly (the tenth main mid-turn assembly 420) adjacent to one side of the circumferential direction of the main mid-turn assembly (the first main mid-turn assembly 411).

The (1-2)-th outer end turn 461-2 may electrically connect another auxiliary mid-turn assembly (the fifth auxiliary mid-turn assembly 435) of the main mid-turn assembly (the first main mid-turn assembly 411) and another auxiliary mid-turn assembly (the first auxiliary mid-turn assembly 431) of another main mid-turn assembly (the tenth main mid-turn assembly 420) adjacent to one side of the circumferential direction of the main mid-turn assembly (the first main mid-turn assembly 411).

The (1-3)-th outer end turn 461-3 may electrically connect another auxiliary mid-turn assembly (the sixth auxiliary mid-turn assembly 436) of the main mid-turn assembly (the first main mid-turn assembly 411) and another auxiliary mid-turn assembly (the fourth auxiliary mid-turn assembly 434) of another main mid-turn assembly (the tenth main mid-turn assembly 420) adjacent to one side of the circumferential direction of the main mid-turn assembly (the first main mid-turn assembly 411).

The (2-1)-th outer end turn 462-1 may electrically connect another auxiliary mid-turn assembly (the third auxiliary mid-turn assembly 433) of another main mid-turn assembly (the tenth main mid-turn assembly 420) adjacent to one side of the circumferential direction of the main mid-turn assembly (the first main mid-turn assembly 411) and one auxiliary mid-turn assembly (the second auxiliary mid-turn assembly 432) of another main mid-turn assembly (the ninth main mid-turn assembly 419) adjacent to one side of the circumferential direction of another main mid-turn assembly (the tenth main mid-turn assembly 420).

The (2-2)-th outer end turn 462-2 may electrically connect another auxiliary mid-turn assembly (the fifth auxiliary mid-turn assembly 435) of another main mid-turn assembly (the tenth main mid-turn assembly 420) adjacent to one side of the circumferential direction of the main mid-turn assembly (the first main mid-turn assembly 411) and another auxiliary mid-turn assembly (the first auxiliary mid-turn assembly 431) of another main mid-turn assembly (the ninth main mid-turn assembly 419) adjacent to one side of the circumferential direction of another main mid-turn assembly (the tenth main mid-turn assembly 420).

The (2-3)-th outer end turn 462-3 may electrically connect another auxiliary mid-turn assembly (the sixth auxiliary mid-turn assembly 436) of another main mid-turn assembly (the tenth main mid-turn assembly 420) adjacent to one side of the circumferential direction of the main mid-turn assembly (the first main mid-turn assembly 411) and another auxiliary mid-turn assembly (the third auxiliary mid-turn assembly 433) of another main mid-turn assembly (the ninth main mid-turn assembly 419) adjacent to one side of the circumferential direction of another main mid-turn assembly (the tenth main mid-turn assembly 420).

A process of supplying a current to the stator PCB pattern 10 according to the fourth embodiment is described below.

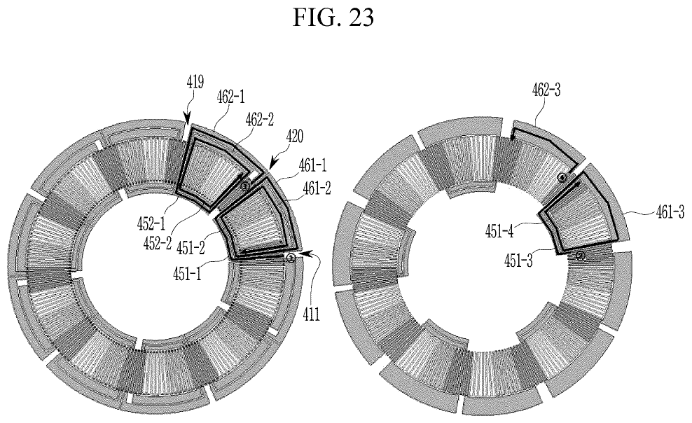

Referring to FIG. 23, a current supplied from a power supply (for example, a battery) flows in the order of one auxiliary mid-turn assembly (the third auxiliary mid-turn assembly 433) of the main mid-turn assembly (the first main mid-turn assembly 411)→the (1-1)-th inner end turn 451-1→one auxiliary mid-turn assembly (the second auxiliary mid-turn assembly 432) of another main mid-turn assembly (the tenth main mid-turn assembly 420) adjacent to one side of the circumferential direction of the main mid-turn assembly (the first main mid-turn assembly 411)→the (1-1)-th outer end turn 461-1→another auxiliary mid-turn assembly (the fourth auxiliary mid-turn assembly 434) of the main mid-turn assembly (the first main mid-turn assembly 411)→the (1-2)-th inner end turn 451-2→another auxiliary mid-turn assembly (the first auxiliary mid-turn assembly 431) of another main mid-turn assembly (the tenth main mid-turn assembly 420) adjacent to one side of the circumferential direction of the main mid-turn assembly (the first main mid-turn assembly 411)→the (1-2)-th outer end turn 461-2→another auxiliary mid-turn assembly (the fifth auxiliary mid-turn assembly 435) of the main mid-turn assembly (the first main mid-turn assembly 411)→the (1-3)-th inner end turn 451-3→another auxiliary mid-turn assembly (the fourth auxiliary mid-turn assembly 434) of another main mid-turn assembly (the tenth main mid-turn assembly 420) adjacent to one side of the circumferential direction of the main mid-turn assembly (the first main mid-turn assembly 411)→the (1-3)-th outer end turn 461-3→another auxiliary mid-turn assembly (the sixth auxiliary mid-turn assembly 436) of the main mid-turn assembly (the first main mid-turn assembly 411)→the (1-4)-th inner end turn 451-4→another auxiliary mid-turn assembly (the third auxiliary mid-turn assembly 433) of another main mid-turn assembly (the tenth main mid-turn assembly 420) adjacent to one side of the circumferential direction of the main mid-turn assembly (the first main mid-turn assembly 411)→the (2-1)-th outer end turn 462-1→one auxiliary mid-turn assembly (the second auxiliary mid-turn assembly 432) of another main mid-turn assembly (the ninth main mid-turn assembly 419) adjacent to one side of the circumferential direction of another main mid-turn assembly (the tenth main mid-turn assembly 420)→the (2-1)-th inner end turn 452-1→another auxiliary mid-turn assembly (the fifth auxiliary mid-turn assembly 435) of another main mid-turn assembly (the tenth main mid-turn assembly 420) adjacent to one side of the circumferential direction of the main mid-turn assembly (the first main mid-turn assembly 411)→the (2-2)-th outer end turn 462-2→another auxiliary mid-turn assembly (the first auxiliary mid-turn assembly 431) of another main mid-turn assembly (the ninth main mid-turn assembly 419) adjacent to one side of the circumferential direction of another main mid-turn assembly (the tenth main mid-turn assembly 420)→the (2-2)-th inner end turn 452-2→another auxiliary mid-turn assembly (the sixth auxiliary mid-turn assembly 436) of another main mid-turn assembly (the tenth main mid-turn assembly 420) adjacent to one side of the circumferential direction of the main mid-turn assembly (the first main mid-turn assembly 411)→the (2-3)-th outer end turn 462-3→another auxiliary mid-turn assembly (the third auxiliary mid-turn assembly 433) of another main mid-turn assembly (the ninth main mid-turn assembly 419) adjacent to one side of the circumferential direction of another main mid-turn assembly (the tenth main mid-turn assembly 420).

In the embodiment, each of the U-phase coil 11, the V-phase coil 12, and the W-phase coil 13 may be wound in the distributed winding form. Accordingly, the stator coil may be wound through various winding methods, and the winding coefficient may be maximized.

In addition, the difference in area between the coil turns on the radially inner side and the coil turns on the radially outer side of the stator PCB pattern 10 may be minimized, and the amount of magnetic flux linking from the permanent magnet 20 to all coil turns may be maximized, so that the design of an efficient axial flux motor may be possible.

While the present disclosure has been described in connection with what is presently considered to be embodiments, it should be understood that the present disclosure is not limited to the disclosed embodiments. On the contrary, it is intended to cover various modifications and equivalent arrangements included within the spirit and scope of the present disclosure.

### DESCRIPTION OF SYMBOLS

10: stator PCB pattern
11: U-phase coil
12: V-phase coil
13: W-phase coil
15: printed circuit board (PCB)
20: permanent magnet
30: rotor core
110: main mid-turn assembly
130: auxiliary mid-turn assembly
140: mid-turn
150: inner end turn
160: outer end turn

What is claimed is:

1. A stator coil comprising:
a U-phase coil, a V-phase coil, and a W-phase coil,
wherein each of the U-phase coil, V-phase coil, and W-phase coil includes:
a plurality of main mid-turn assemblies disposed at set intervals along a circumferential direction; and
a plurality of end turns that electrically connect adjacent main mid-turn assemblies on a radially inner side and a radially outer side, respectively.

2. The stator coil of claim 1, wherein each of the plurality of main mid-turn assemblies includes a plurality of auxiliary mid-turn assemblies disposed along the circumferential direction.

3. The stator coil of claim 2, wherein each of the auxiliary mid-turn assemblies includes a plurality of mid-turns disposed in parallel in an axial direction.

4. The stator coil of claim 3, wherein each end turn of the plurality of end turns includes:
a plurality of inner end turns having an arc shape and positioned radially inside a main mid-turn assembly among the plurality of main mid-turn assemblies; and
a plurality of outer end turns having an arc shape and positioned radially outside the main mid-turn assembly.

5. The stator coil of claim 4, wherein an inner end turn of the plurality of inner end turns electrically connects another main mid-turn assembly and an additional main mid-turn assembly respectively adjacent to a first side and a second side of the circumferential direction of one main mid-turn assembly.

6. The stator coil of claim 5, wherein an outer end turn of the plurality of outer end turns electrically connects the another main mid-turn assembly and the additional main mid-turn assembly respectively adjacent to the first side and the second side of the circumferential direction of the one main mid-turn assembly.

7. The stator coil of claim 6, wherein the plurality of auxiliary mid-turn assemblies includes a first auxiliary mid-turn assembly, a second auxiliary mid-turn assembly, and a third auxiliary mid-turn assembly, and
wherein the inner end turn includes:
a first inner end turn electrically connecting the first auxiliary mid-turn assembly of the one main mid-turn assembly and the third auxiliary mid-turn assembly of the another main mid-turn assembly adjacent to the first side of the circumferential direction of the one main mid-turn assembly;
a (2-1)-th inner end turn electrically connecting the third auxiliary mid-turn assembly of the one main mid-turn assembly and the first auxiliary mid-turn assembly of the additional main mid-turn assembly adjacent to the second side of the circumferential direction of the one main mid-turn assembly; and
a (2-2)-th inner end turn electrically connecting the second auxiliary mid-turn assembly of the one main mid-turn assembly and the second auxiliary mid-turn assembly of the additional main mid-turn assembly adjacent to the second side in the circumferential direction of the one main mid-turn assembly.

8. The stator coil of claim 7, wherein the outer end turn includes:
a (1-1)-th outer end turn electrically connecting the third auxiliary mid-turn assembly of the one main mid-turn assembly and the first auxiliary mid-turn assembly of the another main mid-turn assembly adjacent to the first side of the circumferential direction of the one main mid-turn assembly;
a (1-2)-th outer end turn electrically connecting the first auxiliary mid-turn assembly of the one main mid-turn assembly and the second auxiliary mid-turn assembly of the another main mid-turn assembly adjacent to the first side of the circumferential direction of the one main mid-turn assembly; and
a second outer end turn electrically connecting the second auxiliary mid-turn assembly of the one main mid-turn assembly and the first auxiliary mid-turn assembly of the additional main mid-turn assembly adjacent to the second side of the circumferential direction of the one main mid-turn assembly.

9. The stator coil of claim 6, wherein the plurality of auxiliary mid-turn assemblies includes a first auxiliary mid-turn assembly, a second auxiliary mid-turn assembly, a third auxiliary mid-turn assembly, a fourth auxiliary mid-turn assembly, and a fifth auxiliary mid-turn assembly, and
wherein the inner end turn includes:
a (1-1)-th inner end turn electrically connecting the second auxiliary mid-turn assembly of the one main mid-turn assembly and the fifth auxiliary mid-turn assembly of the another main mid-turn assembly adjacent to the first side of the circumferential direction of the one main mid-turn assembly;
a (1-2)-th inner end turn electrically connecting the third auxiliary mid-turn assembly of the one main mid-turn assembly and the fourth auxiliary mid-turn assembly of the another main mid-turn assembly adjacent to the first side of the circumferential direction of the one main mid-turn assembly;
a (1-3)-th inner end turn electrically connecting the first auxiliary mid-turn assembly of the one main mid-turn assembly and the third auxiliary mid-turn assembly of the another main mid-turn assembly adjacent to the first side of the circumferential direction of the one main mid-turn assembly;
a (2-1)-th inner end turn electrically connecting the fifth auxiliary mid-turn assembly of the one main mid-turn assembly and the first auxiliary mid-turn assembly of the additional main mid-turn assembly adjacent to the second side of the circumferential direction of the one main mid-turn assembly; and
a (2-2)-th inner end turn electrically connecting the fourth auxiliary mid-turn assembly of the one main mid-turn assembly and the second auxiliary mid-turn assembly of the additional main mid-turn assembly adjacent to the second side of the circumferential direction of the one main mid-turn assembly.

10. The stator coil of claim 9, wherein the outer end turn includes:
a (1-1)-th outer end turn electrically connecting the first auxiliary mid-turn assembly of the one main mid-turn assembly and the fifth auxiliary mid-turn assembly of the another main mid-turn assembly adjacent to the first side of the circumferential direction of the one main mid-turn assembly;
a (1-2)-th outer end turn electrically connecting the second auxiliary mid-turn assembly of the one main mid-turn assembly and the fourth auxiliary mid-turn assembly of the another main mid-turn assembly adjacent to the first side of the circumferential direction of the one main mid-turn assembly;
a (2-1)-th outer end turn electrically connecting the third auxiliary mid-turn assembly of the one main mid-turn assembly and the first auxiliary mid-turn assembly of the additional main mid-turn assembly adjacent to the second side of the circumferential direction of the one main mid-turn assembly;
a (2-2)-th outer end turn electrically connecting the fifth auxiliary mid-turn assembly of the one main mid-turn assembly and the second auxiliary mid-turn assembly of the additional main mid-turn assembly adjacent to the second side of the circumferential direction of the one main mid-turn assembly; and
a (2-3)-th outer end turn electrically connecting the fourth auxiliary mid-turn assembly of the one main mid-turn assembly and the third auxiliary mid-turn assembly of the additional main mid-turn assembly adjacent to the second side of the circumferential direction of the one main mid-turn assembly.

11. The stator coil of claim 4, wherein the inner end turn electrically connects one main mid-turn assembly and another main mid-turn assembly adjacent to a first side of the circumferential direction of the one main mid-turn assembly, and
wherein the inner end turn electrically connects the another main mid-turn assembly and an additional main mid-turn assembly adjacent to a first side of the circumferential direction of the another main mid-turn assembly.

12. The stator coil of claim 11, wherein the outer end turn electrically connects the one main mid-turn assembly and a further main mid-turn assembly adjacent to the first side of the circumferential direction of the one main mid-turn assembly, and
wherein the outer end turn electrically connects the additional main mid-turn assembly adjacent to a first side of the circumferential direction of the further main mid-turn assembly.

13. The stator coil of claim 12, wherein the plurality of auxiliary mid-turn assemblies includes a first auxiliary mid-turn assembly, a second auxiliary mid-turn assembly, a third auxiliary mid-turn assembly, and a fourth auxiliary mid-turn assembly, and
wherein the inner end turn includes:
a (1-1)-th inner end turn electrically connecting the second auxiliary mid-turn assembly of the one main mid-turn assembly and the second auxiliary mid-turn assembly of the further main mid-turn assembly adjacent to the first side of the circumferential direction of the one main mid-turn assembly;
a (1-2)-th inner end turn electrically connecting the third auxiliary mid-turn assembly of the one main mid-turn assembly and the first auxiliary mid-turn assembly of the further main mid-turn assembly adjacent to the first side of the circumferential direction of the one main mid-turn assembly;
a (1-3)-th inner end turn electrically connecting the fourth auxiliary mid-turn assembly of the one main mid-turn assembly and the third auxiliary mid-turn assembly of the further main mid-turn assembly adjacent to the first side of the circumferential direction of the one main mid-turn assembly; and
a second inner end turn electrically connecting the first auxiliary mid-turn assembly of extra main mid-turn assembly adjacent to the first side of the circumferential direction of the further main mid-turn assembly and the fourth auxiliary mid-turn assembly of the further main mid-turn assembly adjacent to the first side of the circumferential direction of the one main mid-turn assembly.

14. The stator coil of claim 13, wherein the outer end turn includes:
a (1-1)-th outer end turn electrically connecting the third auxiliary mid-turn assembly of the one main mid-turn assembly and the third auxiliary mid-turn assembly of the further main mid-turn assembly adjacent to the first side of the circumferential direction of the one main mid-turn assembly;
a (1-2)-th outer end turn electrically connecting the fourth auxiliary mid-turn assembly of the one main mid-turn assembly and the first auxiliary mid-turn assembly of the another main mid-turn assembly adjacent to the first side of the circumferential direction of the one main mid-turn assembly;
a (2-1)-th outer end turn electrically connecting the third auxiliary mid-turn assembly of the another main mid-turn assembly adjacent to the first side of the circumferential direction of the one main mid-turn assembly and the first auxiliary mid-turn assembly of the additional main mid-turn assembly adjacent to the first side of the circumferential direction of the another main mid-turn assembly; and
a (2-2)-th outer end turn electrically connecting the fourth auxiliary mid-turn assembly of the another main mid-turn assembly adjacent to the first side of the circumferential direction of the one main mid-turn assembly and the second auxiliary mid-turn assembly of the additional main mid-turn assembly adjacent to the first side of the circumferential direction of the another main mid-turn assembly.

15. The stator coil of claim 12, wherein the plurality of auxiliary mid-turn assemblies includes a first auxiliary mid-turn assembly, a second auxiliary mid-turn assembly, a third auxiliary mid-turn assembly, a fourth auxiliary mid-turn assembly, a fifth auxiliary mid-turn assembly, and a sixth mid-turn auxiliary assembly, and
wherein the inner end turn includes:
a (1-1)-th inner end turn electrically connecting the third auxiliary mid-turn assembly of the one main mid-turn assembly and the second auxiliary mid-turn assembly of the another main mid-turn assembly adjacent to the first side of the circumferential direction of the one main mid-turn assembly;
a (1-2)-th inner end turn electrically connecting the fourth auxiliary mid-turn assembly of the one main mid-turn assembly and the first auxiliary mid-turn assembly of the another main mid-turn assembly adjacent to the first side of the circumferential direction of the one main mid-turn assembly;
a (1-3)-th inner end turn electrically connecting the fifth auxiliary mid-turn assembly of the one main mid-turn assembly and the fourth auxiliary mid-turn assembly of the another main mid-turn assembly adjacent to the first side of the circumferential direction of the one main mid-turn assembly;
a (1-4)-th inner end turn electrically connecting the sixth auxiliary mid-turn assembly of the one main mid-turn assembly and the third auxiliary mid-turn assembly of the another main mid-turn assembly adjacent to the first side of the circumferential direction of the one main mid-turn assembly;
a (2-1)-th inner end turn electrically connecting the fifth auxiliary mid-turn assembly of the another main mid-turn assembly adjacent to the first side of the circumferential direction of the one main mid-turn assembly and the second auxiliary mid-turn assembly of the additional main mid-turn assembly adjacent to the first side of the circumferential direction of the another main mid-turn assembly; and
a (2-2)-th inner end turn electrically connecting the sixth auxiliary mid-turn assembly of the another main mid-turn assembly adjacent to the first side of the circumferential direction of the one main mid-turn assembly and the first auxiliary mid-turn assembly of the additional main mid-turn assembly adjacent to the first side of the circumferential direction of the another main mid-turn assembly.

16. The stator coil of claim 15, wherein the outer end turn includes:
a (1-1)-th outer end turn electrically connecting the fourth auxiliary mid-turn assembly of the one main mid-turn assembly and the second auxiliary mid-turn assembly of the another main mid-turn assembly adjacent to the first side of the circumferential direction of the one main mid-turn assembly;
a (1-2)-th outer end turn electrically connecting the fifth auxiliary mid-turn assembly of the one main mid-turn assembly and the first auxiliary mid-turn assembly of the another main mid-turn assembly adjacent to the first side of the circumferential direction of the one main mid-turn assembly;
a (1-3)-th outer end turn electrically connecting the sixth auxiliary mid-turn assembly of the one main mid-turn assembly and the fourth auxiliary mid-turn assembly of the another main mid-turn assembly adjacent to the first side of the circumferential direction of the one main mid-turn assembly;
a (2-1)-th outer end turn electrically connecting the third auxiliary mid-turn assembly of the another main mid-turn assembly adjacent to the first side of the circumferential direction of the one main mid-turn assembly and the second auxiliary mid-turn assembly of the additional main mid-turn assembly adjacent to the first side of the circumferential direction of the another main mid-turn assembly;
a (2-2)-th outer end turn electrically connecting the fifth auxiliary mid-turn assembly of the another main mid-turn assembly adjacent to the first side of the circumferential direction of the one main mid-turn assembly and the first auxiliary mid-turn assembly of the additional main mid-turn assembly adjacent to the first side of the circumferential direction of the another main mid-turn assembly; and
a (2-3)-th outer end turn electrically connecting the sixth auxiliary mid-turn assembly of the another main mid-turn assembly adjacent to the first side of the circumferential direction of the one main mid-turn assembly and the third auxiliary mid-turn assembly of the additional main mid-turn assembly adjacent to the first side of the circumferential direction of the another main mid-turn assembly.

17. An axial flux motor comprising:
a stator PCB pattern including a stator coil, the stator coil comprising a U-phase coil, a V-phase coil, and a W-phase coil,
a permanent magnet disposed on both sides of the stator PCB pattern; and
a rotor core disposed on both sides of the permanent magnet.

18. The axial flux motor according to claim 17, wherein each of the U-phase coil, V-phase coil, and W-phase coil includes:
a plurality of main mid-turn assemblies disposed at set intervals along a circumferential direction; and
a plurality of end turns that electrically connect adjacent main mid-turn assemblies on a radially inner side and a radially outer side, respectively.

19. The axial flux motor according to claim 18, wherein each of the plurality of main mid-turn assemblies includes a plurality of auxiliary mid-turn assemblies disposed along the circumferential direction.

20. The axial flux motor according to claim 19, wherein each of the auxiliary mid-turn assemblies includes a plurality of mid-turns disposed in parallel in an axial direction.
